(19) United States
(12) Patent Application Publication
(10) Pub. No.: US 2026/0348772 A1
(43) Pub. Date: Nov. 5, 2026

(54) Robust Intelligent Prediction Method for Blower Bearing Temperature Based on Spectral Reconstructed Neural Network

(71) Applicant: Beijing University of Technology, Beijing (CN)

(72) Inventors: Honggui Han, Beijing (CN); Zecheng Tang, Beijing (CN); Xiaolong Wu, Beijing (CN); Zheng Liu, Beijing (CN)

(21) Appl. No.: 19/310,702

(22) Filed: Aug. 26, 2025

(30) Foreign Application Priority Data
Apr. 27, 2025 (CN) 202510539548.1

(51) Int. Cl. G01K 13/08; G01M 13/04; G06N 3/09

(52) U.S. Cl. CPC G01K 13/08; G01M 13/04; G06N 3/09

(57) ABSTRACT

A prediction method for blower bearing temperature based on a spectral reconstructed neural network is disclosed. The method forecasts future bearing temperature with improved accuracy. Multiple operational variables are collected via sensors, including outlet air pressure, drive-end bearing temperature, vibration amplitude, inlet air temperature, motor current, and historical bearing temperature of the blower's main motor. These variables serve as input features for a predictive model using a spectral reconstructed neural network. A spectral reconstruction layer extracts frequency-domain features and smooths input data, while a frequency projection attention mechanism adaptively adjusts weights of frequency components by approximately orthogonal projection of query and key matrices, mitigating concept drift. The method is implemented through a modular system comprising an industrial sensor module, programmable logic controller, database, neural network processor, and display module, supporting intelligent predictive maintenance and enhancing operational stability of blower systems.

### TECHNOLOGY AREA

The present invention relates to a prediction method for blower bearing temperature based on a spectral reconstructed neural network, and a supporting modular integrated prediction system comprising an industrial sensor module, a programmable logic controller module, a database module, a neural network processing unit, and a display module. The system enables real-time acquisition, storage, processing, and visualization of blower operational data to support accurate blower bearing temperature prediction. The blower bearing temperature serves as a key indicator reflecting the operational condition of the equipment, directly representing the bearing's load status, lubrication performance, and overall health, and plays a critical role in determining whether the equipment is operating abnormally. As a typical type of large-scale rotating machinery, blowers are widely utilized across various industries, including wastewater treatment, petrochemical engineering, and power generation. Therefore, predicting blower bearing temperatures is of great significance for equipment condition evaluation, fault early warning, and maintenance strategy formulation. The invention belongs to the technical field of industrial equipment condition monitoring and intelligent maintenance.

### TECHNOLOGY BACKGROUND

As typical large-scale rotating machinery, blowers are widely utilized in industries such as wastewater treatment, power generation, petrochemical engineering, and metallurgy, undertaking crucial functions such as gas transportation and ventilation during industrial processes. During blower operation, the bearing components are subjected to continuous high-speed rotation and heavy loading. The temperature variations of the bearings reflect key aspects such as mechanical loading, wear condition, and lubrication status, making it one of the critical parameters for characterizing equipment operational status. If abnormal bearing temperatures are not detected in a timely manner, they may lead to equipment failures, increased energy consumption, or even threaten the continuity and safety of the entire system operation. Therefore, predicting the blower bearing temperature is an essential approach to ensuring equipment stability and implementing condition-based maintenance.

Existing technologies for monitoring and predicting blower bearing temperature mainly rely on static modeling, empirical threshold determination, or single-variable analysis. These approaches are inadequate for dealing with the time-varying characteristics of operational data distributions. Under multiple operating conditions, equipment aging, or external environmental fluctuations, blower operational data is prone to concept drift, where the statistical properties of input variables change over time. This leads to model performance degradation and unstable prediction results. Traditional methods generally lack the capability to recognize and model concept drift, making it difficult to maintain prediction accuracy and reliability over long-term operation and complex working conditions.

In order to solve the above problems, the present invention designs a prediction method for blower bearing temperature based on spectral reconstructed neural network. The method collects key operational variables from blower systems via industrial sensors, constructs a spectral reconstructed neural network prediction model for bearing temperature forecasting, and dynamically updates model parameters based on operational data, forming a prediction model that adapts to concept drift. To support the implementation of this method, a modular integrated prediction system comprising industrial sensors, a programmable logic controller, a database module, a neural network processing module, and a display module is deployed, enabling real-time data acquisition, intelligent prediction, and result visualization, thereby achieving accurate prediction of future blower bearing temperature states.

### SUMMARY OF THE INVENTION

A prediction method for blower bearing temperature based on spectral reconstructed neural network, comprising the following device structure:
a modular integrated prediction system, comprising an industrial sensor module, a programmable logic controller module, a database module, a neural network processing unit, and a display module; the industrial sensor module comprises a pressure transmitter, a triaxial accelerometer, a temperature transmitter, a current transformer, and two resistance temperature detectors, the function of the industrial sensor module is to collect operational data of the blower system, including outlet air pressure, shaft vibration, inlet air temperature, motor current, drive-end bearing temperature, and main motor bearing temperature; the function of the programmable logic controller module is to receive signals from the industrial sensor module and transmit the collected data to the database module through an industrial communication protocol; the function of the database module is to store the time-series operational data for subsequent temperature prediction; the function of the neural network processing unit is to execute a spectral reconstructed neural network to predict blower bearing temperature based on the stored historical data; the function of the display module is to display the predicted temperature result;
the operational workflow of the modular integrated prediction system is as follows: first, operational data including outlet air pressure, shaft vibration, inlet air temperature, main motor current, drive-end bearing temperature, and main motor bearing temperature is continuously collected by the industrial sensor module from the blower system; second, the collected data is transmitted by the programmable logic controller module to the database module via an industrial communication protocol; third, the database module stores the incoming time-series data; fourth, the neural network processing unit accesses the historical operational data from the database module and performs blower main motor bearing temperature prediction using a spectral reconstructed neural network; finally, the predicted temperature result is visualized by the display module for real-time monitoring, with the specific prediction method as follows:
1. collect blower data: the input variables of the spectral reconstructed neural network include outlet air pressure, drive-end bearing temperature of the high-speed shaft, vibration amplitude of the high-speed shaft, inlet air temperature, main motor current, and the historical bearing temperature of the blower's main motor, the output variable is the predicted main motor bearing temperature of the blower; the main motor is a three-phase asynchronous motor configured to provide direct driving power to the blower system, with an output shaft connected to a high-speed shaft for driving the overall operation of the blower; the high-speed shaft is a high-speed rotating shaft segment configured to connect the output shaft of the main motor to an impeller transmission system, and used for transmitting rotational power from the motor to the blower; use a pressure transmitter installed on the outlet pipeline to collect the outlet air pressure data at time t as a vector x(t)=[x¹(t−L+1), . . . , x¹(t−1), x¹(t)], use a resistance temperature detector mounted on the bearing housing to collect the drive-end bearing temperature of the high-speed shaft at time t as a vector x²(t)=[x²(t−L+1), x²(t-x²(t)], use a triaxial accelerometer to collect the vibration data of the high-speed shaft at time t as a vector x³(t)=[x³(t−L+1), . . . , x³(t−1), x³(t)], use a temperature transmitter to collect the inlet air temperature at time t as a vector x⁴(t)=[x⁴(t−L+1), . . . , x⁴(t−1), x⁴(t)], use a current transformer to collect the main motor current at time t as a vector x⁵(t)=[x⁵(t−L+1), . . . , x⁵(t−1), x⁵(t)], use a resistance temperature detector to collect the historical bearing temperature of the blower's main motor at time t as a vector x⁶(t−L+1), . . . , x⁶(t−1), x⁶(t)], construct the input sample matrix at time t as X(t)=[x¹(t)T, . . . , xⁿ(t)^{T}, . . . , x⁶(t)^{T}]^{T}, xⁿ(t=[xⁿ(t−L+1), . . . , xⁿ(t−1), xⁿ(t)], n=1, 2, . . . , 6, t=L+1,L+2, . . . ,N+L+1, Nis the number of sample sequences, L isg the number of time steps per input variable, and T represents matrix transposition;
2. establish a bearing temperature prediction model for blowers: construct a blower bearing temperature prediction model based on a spectral reconstructed neural network, wherein the spectral reconstructed neural network comprises an input layer, a spectrum reconstruction layer, a spectrum projection attention layer, and an output layer connected in sequence;
input layer: input the sample matrix into the model row by row, and the output of the input layer at time t is X(t)=[x¹(t)^{T}, x²(t)^{T}, x⁶(t)^{T}]T;
spectrum reconstruction layer: perform a real-valued discrete cosine transform on the input sample matrix, where each row of the input is mapped to a real-valued vector consisting of M frequency projection values, which is calculated as follows:

$${F}_{m}^{n} ( t ) = {\sum }_{k = 0}^{L - 1} {x}^{n} ( t - L + k + 1 ) \times cos ( \frac{6.28 mk}{L} ) \qquad ( 1 )$$

$$where$$

$${F}_{m}^{n} ( t )$$

is the mth frequency projection value of the nth row input sample at time t, cos(·) denotes the cosine function,

$${F}^{n} ( t ) = [ {F}_{1}^{n} ( t ) , … , {F}_{m}^{n} ( t ) , … , {F}_{M}^{n} ( t ) ] ,$$

Fⁿ(t) is the nth frequency projection vector of the input sample matrix at time t, and m=1, 2, . . . , M; apply smoothing to the frequency projection vector, and the smoothed frequency projection vector of the nth row is calculated as follows:

$${a}^{n} ( t ) = 0.9 {a}^{n} ( t - 1 ) + 0.1 ‖ {F}^{n} ( t ) - {F}^{n} ( t - 1 ) ‖ \qquad ( 2 )$$

$${b}^{n} ( t ) = 0.9 {b}^{n} ( t - 1 ) + 0.1 ( 1 - ‖ {F}^{n} ( t ) - {F}^{n} ( t - 1 ) ‖ ) \qquad ( 3 )$$

$${α}^{n} ( t ) = \frac{{a}^{n} ( t )}{{a}^{n} ( t ) + {b}^{n} ( t )} \qquad ( 4 )$$

$${\hat{F}}^{n} ( t ) = {α}^{n} ( t ) {F}^{n} ( t ) + ( 1 - {α}^{n} ( t ) ) {F}^{n} ( t - 1 ) , \qquad ( 5 )$$

where aⁿ(t) is the weighted cumulative value of the variation amplitude of the nth frequency projection vector at time t, in which the variation amplitude refers to the Euclidean distance between the current frequency projection vector and that of the previous time step, aⁿ(t−1) is the weighted cumulative value of the variation amplitude of the nth frequency projection vector at the previous time step t−1, Fⁿ(t−1) is the nth frequency projection vector of the input sample matrix at time t−1,

$${F}^{n} ( t - 1 ) = [ {F}_{1}^{n} ( t - 1 ) , … , {F}_{m}^{n} ( t - 1 ) , … , {F}_{M}^{n} ( t - 1 ) ] ,$$

$${F}_{m}^{n} ( t - 1 )$$

is the mth frequency projection value of the nth row in the input sample matrix at the previous time t−1, ∥·∥ denotes the Euclidean norm of a vector, bⁿ(t) is the weighted cumulative value of the stability of variation for the nth frequency projection vector at time t, where the stability of variation refers to the difference between 1 and the Euclidean distance between the current frequency projection vector and that of the previous time step, bⁿ(t−1) is the weighted cumulative value of the stability of variation for the nth frequency projection vector at the previous time t−1, \hat{F}ⁿ(t) is the nth smoothed frequency projection vector,

$${\hat{F}}^{n} ( t ) = [ {\hat{F}}_{1}^{n} ( t ) , … , {\hat{F}}_{m}^{n} ( t ) , … , {\hat{F}}_{M}^{n} ( t ) ] , {\hat{F}}_{m}^{n} ( t )$$

is the mth smoothed frequency projection value of the nth row input sample at time t, αⁿ(t) is the smoothing coefficient corresponding to the nth frequency projection vector, α(t)=[α¹(t),α²(t), . . . ,α⁶(t)]^{T}, α(t) is the smoothing coefficient vector at time t; combine the smoothed frequency projection vectors to form a frequency embedding matrix, and perform a linear transformation on the frequency embedding matrix to obtain the token representation matrix, calculated as follows:

Z₁(t)=E(t)W₁(t)+b₁(t) (6)

where E(t) is the frequency embedding matrix at time t, E(t)=[\hat{F}¹(t)^{T},\hat{F}²(t)^{T}, . . . ,\hat{F}⁶(t)^{T}], and Z₁(t) is the token representation matrix at time t,

$${Z}_{1} ( t ) = {[ {{Z}_{1}^{1} ( t )}^{T} , … , {{Z}_{1}^{m} ( t )}^{T} , … , {{Z}_{1}^{M} ( t )}^{T} ]}^{T} , {Z}_{1}^{m} ( t )$$

is the mth row vector of the token representation matrix,

$${Z}_{1}^{m} ( t ) = [ {Z}_{1}^{m , 1} ( t ) , … , {Z}_{1}^{m , i} ( t ) , … , {Z}_{1}^{m , D} ( t ) ] , {Z}_{1}^{m , i} ( t )$$

is the element in the ith column of the mth row of the token representation matrix, W₁(t) is the frequency embedding weight matrix at time t,

$${W}_{1} ( t ) = {[ {{W}_{1}^{1} ( t )}^{T} , … , {{W}_{1}^{n} ( t )}^{T} , … , {{W}_{1}^{6} ( t )}^{T} ]}^{T} , {W}_{1}^{n} ( t )$$

is the nth row vector of the frequency embedding weight matrix,

$${W}_{1}^{n} ( t ) = [ {W}_{1}^{n , 1} ( t ) , … , {W}_{1}^{n , i} ( t ) , … , {W}_{1}^{n , D} ( t ) ] , {W}_{1}^{n , i} ( t )$$

is the element in the ith column of the nth row of the frequency embedding weight matrix, b₁(t) is the frequency embedding bias vector at time t,

$${b}_{1} ( t ) = [ {b}_{1}^{1} ( t ) , … , {b}_{1}^{i} ( t ) , … , {b}_{1}^{D} ( t ) ] , {b}_{1}^{i} ( t )$$

is the ith frequency embedding bias term, D is the embedding dimension of the token representation, and i=1, 2, . . . , D;
encoder layer: consists of three stacked encoder modules, where s=1, 2, 3 indicates the index of the sth encoder module, each encoder module sequentially performs frequency projection attention, residual connection, layer normalization, feedforward transformation, another residual connection, and layer normalization on the input token representation matrix, the frequency projection attention operation constructs a frequency projection matrix, which is designed to partition the attention representation into subspaces of new and old patterns, thereby enhancing the model's adaptability to concept drift, the frequency projection matrix is calculated as follows:

P(t)=E(t)a(t)diag(Z₁(t)^{T}Z₁(t))^{T} (7)

where P(t) is the frequency projection matrix at time t, P(t)=[P¹(t)^{T}, . . . , P^{m}(t)^{T}, . . . , P^{M}(t)^{T}]^{T}, P^{m}(t) is the mth row vector of the first frequency projection matrix at time t, P^{m}(t)=[P^{m,1}(t), . . . , P^{m,j} (t)], . . . , P^{m,M} (t) p^{m,j} (t) is the element in the jth column of the mth row of the frequency projection matrix at time t, diag(⋅) extracts the diagonal elements of a matrix and outputs them as a column vector, j=1, 2, . . . , M; the query matrix, key matrix, and value matrix of the sth encoder module are calculated as follows:

Qₛ(t)=Zₛ(t)W_{Q,s}(t) (8)

Kₛ(t)=Zₛ(t)_{K,s}(t) (9)

Vₛ(t)=Zₛ(t)W_{V,s}(t) (10)

where Qₛ(t) is the query matrix of the sth encoder module at time t,

$${Q}_{s} ( t ) = {[ {{Q}_{s}^{1} ( t )}^{T} , … , {{Q}_{s}^{m} ( t )}^{T} , … , {{Q}_{s}^{M} ( t )}^{T} ]}^{T} , {Q}_{s}^{m} ( t )$$

is the mth row vector of the query matrix of the sth encoder module,

$${Q}_{s}^{m} ( t ) = [ {Q}_{s}^{m , 1} ( t ) , … , {Q}_{s}^{m , i} ( t ) , … , {Q}_{s}^{m , D} ( t ) ] , {Q}_{s}^{m , i} ( t )$$

is the element in the ith column of the mth row of the query matrix of the sth encoder module, W_{Q,s}(t) is the query weight matrix of the sth encoder module at time t,

$${W}_{Q , s} ( t ) = {[ {{W}_{Q , s}^{1} ( t )}^{T} , … , {{W}_{Q , s}^{i} ( t )}^{T} , … , {{W}_{Q , s}^{64} ( t )}^{T} ]}^{T} , {W}_{Q , s}^{i} ( t ) \qquad ( i )$$

is the ith row vector of the query weight matrix of the sth encoder module at time t,

$${W}_{Q , s}^{i} ( t ) = [ {W}_{Q , s}^{i , 1} ( t ) , … , {W}_{Q , s}^{i , l} ( t ) , … , {W}_{Q , s}^{i , D} ( t ) ] , {W}_{Q , s}^{i , l} ( t )$$

is the element in the lth column of the ith row of the query weight matrix of the sth encoder module at time t, Kₛ(t) is the key matrix of the sth encoder module at time t,

$${K}_{s} ( t ) = {[ {{K}_{s}^{1} ( t )}^{T} , … , {{K}_{s}^{m} ( t )}^{T} , … , {{K}_{s}^{M} ( t )}^{T} ]}^{T} , {K}_{s}^{m} ( t )$$

is the element in the ith column of the mth row of the key matrix of the sth encoder module at time t,

$${K}_{s}^{m} ( t ) = [ {K}_{s}^{m , 1} ( t ) , … , {K}_{s}^{m , i} ( t ) , … , {K}_{s}^{m , D} ( t ) ] , {K}_{s}^{m , i} ( t )$$

is the element in the ith column of the mth row of the key matrix of the sth encoder module at time t, W_{K,s}(t) is the key weight matrix of the sth encoder module at time t,

$${W}_{K , s} ( t ) = {[ {{W}_{K , s}^{1} ( t )}^{T} , … , {{W}_{K , s}^{i} ( t )}^{T} , … , {{W}_{K , s}^{D} ( t )}^{T} ]}^{T} , {W}_{K , s}^{m} ( t )$$

is the ith row vector of the key weight matrix of the sth encoder module at time t,

$${W}_{K , s}^{i} ( t ) = [ {W}_{K , s}^{i , 1} ( t ) , … , {W}_{K , s}^{i , l} ( t ) , … , {W}_{K , s}^{i , 64} ( t ) ] , {W}_{K , s}^{i , l} ( t )$$

is the element in the lth column of the ith row of the key weight matrix of the sth encoder module at time t, Vₛ(t) is the value matrix of the sth encoder module at time t,

$${V}_{s} ( t ) = {[ {{V}_{s}^{1} ( t )}^{T} , … , {{V}_{s}^{m} ( t )}^{T} , … , {{V}_{s}^{M} ( t )}^{T} ]}^{T} , {V}_{s}^{m} ( t )$$

is the mth row vector of the value matrix of the sth encoder module at time t,

$${V}_{s}^{m} ( t ) = [ {V}_{s}^{m , 1} ( t ) , … , {V}_{s}^{m , i} ( t ) , … , {V}_{s}^{m , D} ( t ) ] , {V}_{s}^{m , i} ( t )$$

is the element in the ith column of the mth row of the value matrix of the sth encoder module at time t, W_{V,s}(t) is the value weight matrix of the sth encoder module at time t,

$${W}_{V , s} ( t ) = {[ {{W}_{V , s}^{1} ( t )}^{T} , … , {{W}_{V , s}^{i} ( t )}^{T} , … , {{W}_{V , s}^{D} ( t )}^{T} ]}^{T} , {{W}_{V , s}^{i} ( t )}^{T}$$

is the ith row vector of the value weight matrix of the sth encoder module at time t,

$${W}_{V , s}^{i} ( t ) = [ {W}_{V , s}^{i , 1} ( t ) , … , {W}_{V , s}^{i , l} ( t ) , … , {W}_{V , s}^{i , D} ( t ) ] , {W}_{V , s}^{i , l} ( t )$$

is the element in the lth column of the ith row of the value weight matrix of the sth encoder module at time t, and l=1, 2, . . . , D; the output of the frequency projection attention is calculated as follows:

A_{1,s}(t)=softmax(P(t)Qₛ(t)Kₛ(t)^{T}P(t)^{T}) (11)

A_{2,s}(t)=softmax((I−P(t))Qₛ(t)Kₛ(t)^{T}(I−P(t))^{T}) (12)

Oₛ(t)=(A_{1,s}(t)+A_{2,s}(t))Vₛ(t) (13)

where A_{1,s}(t) is the first attention matrix of the sth encoder module at time t,

$${A}_{1 , s} ( t ) = {[ {{A}_{1 , s}^{1} ( t )}^{T} , … , {{A}_{1 , s}^{m} ( t )}^{T} , … , {{A}_{1 , s}^{M} ( t )}^{T} ]}^{T} , {A}_{1 , s}^{m} ( t )$$

is the mth row vector of the first attention matrix of the sth encoder module at time t,

$${A}_{1 , s}^{m} ( t ) = [ {A}_{1 , s}^{m , 1} ( t ) , … , {A}_{1 , s}^{m , j} ( t ) , … , {A}_{1 , s}^{m , M} ( t ) ] , {A}_{1 , s}^{m , j} ( t )$$

is the element in the jth column of the mth row of the first attention matrix of the sth encoder module at time t, I is the identity matrix, A_{2,s} (t) is the second attention matrix of the sth encoder module at time t,

$${A}_{2 , s} ( t ) = {[ {{A}_{2 , s}^{1} ( t )}^{T} , … , {{A}_{2 , s}^{m} ( t )}^{T} , … , {{A}_{2 , s}^{M} ( t )}^{T} ]}^{T} , {A}_{2 , s}^{m} ( t )$$

is the mth row vector of the second attention matrix of the sth encoder module at time t,

$${A}_{2 , s}^{m} ( t ) = [ {A}_{2 , s}^{m , 1} ( t ) , … , {A}_{2 , s}^{m , j} ( t ) , … , {A}_{2 , s}^{m , M} ( t ) ] , {A}_{2 , s}^{m , j} ( t )$$

is the element in the jth column of the mth row of the second attention matrix of the sth encoder module at time t, softmax( ) denotes the row-wise normalization of the input matrix such that the sum of each row is equal to 1, Oₛ(t) is the attention output matrix of the sth encoder module at time t,

$${O}_{s} ( t ) = {[ {{O}_{s}^{1} ( t )}^{T} , … , {{O}_{s}^{m} ( t )}^{T} , … , {{O}_{s}^{M} ( t )}^{T} ]}^{T} , {O}_{s}^{m} ( t )$$

is the mth row vector of the attention output matrix of the sth encoder module at time t,

$${O}_{s}^{m} ( t ) = [ {O}_{s}^{m , 1} ( t ) , … , {O}_{s}^{m , i} ( t ) , … , {O}_{s}^{m , D} ( t ) ] , {O}_{s}^{m , i} ( t )$$

is the element in the ith column of the mth row of the attention output matrix of the sth encoder module at time t, perform a residual connection operation and a layer normalization operation on the attention output matrix Oₛ(t) to obtain the residual updated output matrix of the sth encoder module Rₛ(t),

$${R}_{s} ( t ) = {[ {{R}_{s}^{1} ( t )}^{T} , … , {{R}_{s}^{m} ( t )}^{T} , … , {{R}_{s}^{M} ( t )}^{T} ]}^{T} , {R}_{s}^{m} ( t )$$

is the mth row vector of the residual updated output matrix of the sth encoder module at time t,

$${R}_{s}^{m} ( t ) = [ {R}_{s}^{m , 1} ( t ) , … , {R}_{s}^{m , i} ( t ) , … , {R}_{s}^{m , D} ( t ) ] , {R}_{s}^{m , i} ( t )$$

is the element in the ith column of the mth row of the residual updated output matrix of the sth encoder module at time t; feed the residual updated matrix into a feedforward neural network, the feedforward neural network consists of a first linear transformation layer with input dimension D and output dimension D, and a second linear transformation layer with input dimension D and output dimension D, with a nonlinear activation layer connected between them, the nonlinear activation function is a rectified linear unit (ReLU), which is used for dimensional reconstruction and feature mapping of the token representation vectors, where the dimension D is equal to the embedding dimension of the token representation; the feedforward output of the sth encoder module is calculated as follows:

\tilde{R}ₛ(t)=ReLU(Rₛ(t)·W_{2,s}(t)+b_{2,s}(t))W_{3,s}(t)+b_{3,s}(t) (14)

where \tilde{R}ₛ(t) is the feedforward output matrix of the sth encoder module at time t,

$${\tilde{R}}_{s} ( t ) = {[ {{\tilde{R}}_{s}^{1} ( t )}^{T} , … , {{\tilde{R}}_{s}^{m} ( t )}^{T} , … , {{\tilde{R}}_{s}^{M} ( t )}^{T} ]}^{T}$$

is the mth row vector of the feedforward output matrix of the sth encoder module at time t,

$${\tilde{R}}_{s}^{m} ( t ) = [ {\tilde{R}}_{s}^{m , 1} ( t ) , … , {\tilde{R}}_{s}^{m , i} ( t ) , … , {\tilde{R}}_{s}^{m , D} ( t ) ] , {\tilde{R}}_{s}^{m , i} ( t )$$

is the element in the ith column of the mth row of the feedforward output matrix of the sth encoder module at time t, ReLU(⋅) is the rectified linear unit activation function, W_{2,s} (t) is the first linear transformation weight matrix of the sth encoder module at time t,

$${W}_{2 , s} ( t ) = {[ {{W}_{2 , s}^{1} ( t )}^{T} , … , {{W}_{2 , s}^{t} ( t )}^{T} , … , {{W}_{2 , s}^{D} ( t )}^{T} ]}^{T} , {W}_{2 , s}^{i} ( t )$$

is the ith row vector of the first linear transformation weight matrix of the sth encoder module at time t,

$${W}_{2 , s}^{i} ( t ) = [ {W}_{2 , s}^{i , 1} ( t ) , … , {W}_{2 , s}^{i , t} ( t ) , … , {W}_{2 , s}^{i , D} ( t ) ] , {W}_{2 , s}^{i , l} ( t )$$

is the element in the lth column of the ith row of the first linear transformation weight matrix of the sth encoder module at time t, b_{2,s} (t) is the first linear transformation bias vector of the sth encoder module at time t,

$${b}_{2 , s} ( t ) = [ {b}_{2 , s}^{1} ( t ) , … , {b}_{2 , s}^{l} ( t ) , … , {b}_{2 , s}^{D} ( t ) ] , {b}_{2 , s}^{l} ( t )$$

is the lth element of the first linear transformation bias vector of the sth encoder module at time t, W_{3,s} (t) is the second linear transformation weight matrix of the sth encoder module at time t,

$${W}_{3 , s} ( t ) = {[ {{W}_{3 , s}^{1} ( t )}^{T} , … , {{W}_{3 , s}^{i} ( t )}^{T} , … , {{W}_{3 , s}^{D} ( t )}^{T} ]}^{T} , {W}_{3 , s}^{i} ( t )$$

is the ith row vector of the second linear transformation weight matrix of the sth encoder module at time t,

$${W}_{3 , s}^{i} ( t ) = [ {W}_{3 , s}^{i , 1} ( t ) , … , {W}_{3 , s}^{i , l} ( t ) , … , {W}_{3 , s}^{i , D} ( t ) ] , {W}_{3 , s}^{i , l} ( t )$$

is the element in the lth column of the ith row of the second linear transformation weight matrix of the sth encoder module at time t, b_{3,s} (t) is the second linear transformation bias vector of the sth encoder module at time t,

$${b}_{3 , s} ( t ) = [ {b}_{3 , s}^{1} ( t ) , … , {b}_{3 , s}^{l} ( t ) , … , {b}_{3 , s}^{D} ( t ) ] , {b}_{3 , s}^{l} ( t )$$

is the lth element of the second linear transformation bias vector of the sth encoder module at time t, perform a residual connection operation and a layer normalization operation on the feedforward output matrix of the sth encoder module \tilde{R}ₛ(t) to obtain the token representation matrix output by the sth encoder module Zₛ₊₁(t) at time t,

$${Z}_{s + 1} ( t ) = {[ {{Z}_{s + 1}^{1} ( t )}^{T} , … , {{Z}_{s + 1}^{m} ( t )}^{T} , … , {{Z}_{s + 1}^{M} ( t )}^{T} ]}^{T} , {Z}_{s + 1}^{m} ( t )$$

is the mth row vector of the token representation matrix output by the sth encoder module at time t,

$${Z}_{s + 1}^{m} ( t ) = [ {Z}_{s + 1}^{m , 1} ( t ) , … , {Z}_{s + 1}^{m , i} ( t ) , … , {Z}_{s + 1}^{m , D} ( t ) ] , {Z}_{s + 1}^{m , i} ( t )$$

is the element in the ith column of the mth row of the token representation matrix output by the sth encoder module at time t;
output layer: apply a linear regression layer to map the token representation matrix output by the third encoder module to the final output of the model, and the model output is calculated as follows:

ŷ(t)=Z₄(t)W₄(t)+b₄(t) (15)

where ŷ(t) is the predicted output value of the main motor bearing temperature at time t, in degrees Celsius, W₄(t) is the weight vector of the linear regression layer in the output layer at time t,

$${W}_{4} ( t ) = {[ {W}_{4}^{1} ( t ) , … , {W}_{4}^{i} ( t ) , … , {W}_{4}^{D} ( t ) ]}^{T} , {W}_{4}^{i} ( t )$$

is the ith element of the linear regression weight vector at time t, b₄(t) is the bias term of the linear regression layer;
3. train the parameters of the blower bearing temperature prediction model:
\textcircled{1} define the loss function of the model as:

$$J ( t ) = \frac{1}{2} {( \hat{y} ( t ) - y ( t ) )}^{2} \qquad ( 16 )$$

where J(t) is the loss of the model at time t, y(t) is the actual measured main motor bearing temperature at time t, in degrees Celsius, which is used as a supervision signal for model training;
\textcircled{2} set the current training time to t, initialize the training epoch counter τ=1, and fix the number of training iterations to 20; initialize the model's weight parameters and bias parameters, where the weight parameters are randomly initialized within the range [−0.2, 0.2], and the bias parameters are initialized to 0;
\textcircled{3} compute the actual output of the model at time t during the τth training iteration ŷ^{τ}(t) using equations (1)-(15), compute the loss of the model at time t during the τth training iteration J^{τ}(t) using equation (16), and update the weight matrices and bias vectors using the gradient descent method, with the update formulas given as follows:

$$\{ \begin{matrix}{W}_{1}^{n , i , τ + 1} ( t ) = {W}_{1}^{n , i , τ} ( t ) + 0.01 \cdot \partial {J}^{τ} ( t ) / \partial {W}_{1}^{n , i , τ} ( t ) \\ {W}_{Q , s}^{i , l , τ + 1} ( t ) = {W}_{Q , s}^{i , l , τ} ( t ) + 0.01 \cdot \partial {J}^{τ} ( t ) / \partial {W}_{Q , s}^{i , l , τ} ( t ) \\ {W}_{K , s}^{i , l , τ + 1} ( t ) = {W}_{K , s}^{i , l , τ} ( t ) + 0.01 \cdot \partial {J}^{τ} ( t ) / \partial {W}_{K , s}^{i , l , τ} ( t ) \\ {W}_{V , s}^{i , l , τ + 1} ( t ) = {W}_{V , s}^{i , l , τ} ( t ) + 0.01 \cdot \partial {J}^{τ} ( t ) / \partial {W}_{V , s}^{i , l , τ} ( t ) \\ {W}_{2 , s}^{i , l , τ + 1} ( t ) = {W}_{2 , s}^{i , l , τ} ( t ) + 0.01 \cdot \partial {J}^{τ} ( t ) / \partial {W}_{2 , s}^{i , l , τ} ( t ) \\ {W}_{3 , s}^{i , l , τ + 1} ( t ) = {W}_{3 , s}^{i , l , τ} ( t ) + 0.01 \cdot \partial {J}^{τ} ( t ) / \partial {W}_{3 , s}^{i , l , τ} ( t ) \\ {W}_{4}^{i , τ + 1} ( t ) = {W}_{4}^{i , τ} ( t ) + 0.01 \cdot \partial {J}^{τ} ( t ) / \partial {W}_{4}^{i , τ} ( t )\end{matrix} \qquad ( 17 )$$

$$\{ \begin{matrix}{b}_{1}^{i , τ + 1} ( t ) = {b}_{1}^{i , τ} ( t ) + 0.01 \cdot \partial {J}^{τ} ( t ) / \partial {b}_{1}^{i , τ} ( t ) \\ {b}_{2 , s}^{l , τ + 1} ( t ) = {b}_{2 , s}^{l , τ} ( t ) + 0.01 \cdot \partial {J}^{τ} ( t ) / \partial {b}_{2 , s}^{l , τ} ( t ) \\ {b}_{3 , s}^{l , τ + 1} ( t ) = {b}_{3 , s}^{l , τ} ( t ) + 0.01 \cdot \partial {J}^{τ} ( t ) / \partial {b}_{3 , s}^{l , τ} ( t ) \\ {b}_{4}^{τ + 1} ( t ) = {b}_{4}^{τ} ( t ) + 0.01 \cdot \partial {J}^{τ} ( t ) / \partial {b}_{4}^{τ} ( t )\end{matrix} \qquad ( 18 )$$

$$where {W}_{1}^{n , i , τ} ( t )$$

is the coefficient at the ith column of the nth row of the frequency embedding weight matrix during the τth training iteration at time t,

$${W}_{Q , s}^{i , l , τ} ( t )$$

is the coefficient at the lth column of the ith row of the sth query weight matrix during the τth training iteration at time t,

$${W}_{K , s}^{i , l , τ} ( t )$$

is the coefficient at the ith column of the mth row of the sth key weight matrix during the τth training iteration at time t,

$${W}_{V , s}^{i , l , τ} ( t )$$

is the coefficient at the ith column of the mth row of the sth value weight matrix during the τth training iteration at time t,

$${W}_{2 , s}^{i , l , τ} ( t )$$

is the coefficient at the lth column of the ith row of the first linear transformation weight matrix of the sth encoder module during the τth training iteration at time t,

$${W}_{3 , s}^{i , l , τ} ( t )$$

is the coefficient at the lth column of the ith row of the second linear transformation weight matrix of the sth encoder module during the τth training iteration at time t,

$${W}_{4}^{i , τ} ( t )$$

is the ith coefficient of the linear regression weight vector in the output layer during the τth training iteration at time t,

$${W}_{1}^{n , i , τ + 1} ( t )$$

is the coefficient at the ith column of the nth row of the frequency embedding weight matrix during the (τ+1)th training iteration at time t,

$${W}_{Q , s}^{i , l , τ + 1} ( t )$$

is the coefficient at the lth column of the ith row of the sth query weight matrix during the (τ+1)th training iteration at time t,

$${W}_{K , s}^{i , l , τ + 1} ( t )$$

is the coefficient at the ith column of the mth row of the sth key weight matrix during the (τ+1)th training iteration at time t,

$${W}_{V , s}^{i , l , τ + 1} ( t )$$

is the coefficient at the ith column of the mth row of the sth value weight matrix during the (τ+1)th training iteration at time t,

$${W}_{2 , s}^{i , l , τ + 1} ( t )$$

is the coefficient at the lth column of the ith row of the first linear transformation weight matrix of the sth encoder module during the (τ+1)th training iteration at time t,

$${W}_{3 , s}^{i , l , τ + 1} ( t )$$

is the coefficient at the lth column of the ith row of the second linear transformation weight matrix of the sth encoder module during the (τ+1)th training iteration at time t,

$${W}_{4}^{i , τ + 1} ( t )$$

is the ith coefficient of the linear regression weight vector in the output layer during the (τ+1)th training iteration at time t,

$$\partial {J}^{τ} ( t ) / \partial {W}_{1}^{n , i , τ} ( t )$$

is the partial derivative of J^{τ}(t) with respect to

$${W}_{1}^{n , i , τ} ( t ) , \partial {J}^{τ} ( t ) / \partial {W}_{Q , s}^{i , l , τ} ( t )$$

is the partial derivative of J^{τ}(t) with respect to

$${W}_{Q , s}^{i , l , τ} ( t ) , \partial {J}^{τ} ( t ) / \partial {W}_{K , s}^{i , l , τ} ( t )$$

is the partial derivative of Jτ(t) with respect to

$${W}_{K , s}^{i , l , τ} ( t ) , \partial {J}^{τ} ( t ) / \partial {W}_{V , s}^{i , l , τ} ( t )$$

is the partial derivative of Jτ(t) with respect to

$${W}_{V , s}^{i , l , τ} ( t ) , \partial {J}^{τ} ( t ) / \partial {W}_{2 , s}^{i , l , τ} ( t )$$

is the partial derivative of J^{τ}(t) with respect to

$${W}_{2 , s}^{i , l , τ} ( t ) , \partial {J}^{τ} ( t ) / \partial {W}_{3 , s}^{i , l , τ} ( t )$$

is the partial derivative of J^{τ}(t) with respect to

$${W}_{3 , s}^{i , l , τ} ( t ) , \partial {J}^{τ} ( t ) / \partial {W}_{4}^{i , τ} ( t )$$

is the partial derivative of J^{τ}(t) with respect to

$${W}_{4}^{i , τ} ( t ) , {b}_{1}^{i , τ} ( t )$$

is the ith frequency embedding bias term during the τth training iteration at time t,

$${b}_{2 , s}^{l , τ} ( t )$$

is the lth bias term of the first linear transformation in the sth encoder module during the τth training iteration at time t,

$${b}_{3 , s}^{l , τ} ( t )$$

is the lth bias term of the second linear transformation in the sth encoder module during the τth training iteration at time t,

$${b}_{4}^{τ} ( t )$$

is the lth bias term of the second linear transformation in the sth encoder module during the τth training iteration at time t,

$${b}_{1}^{i , τ + 1} ( t )$$

is the ith frequency embedding bias term during the (τ+1)th training iteration at time t,

$${b}_{2 s}^{l , τ + 1} ( t )$$

is the lth bias term of the first linear transformation in the sth encoder module during the (τ+1)th training iteration at time t,

$${b}_{3 , s}^{l , τ + 1} ( t )$$

is the lth bias term of the second linear transformation in the sth encoder module during the (τ+1)th training iteration at time t,

$${b}_{4}^{τ + 1} ( t )$$

is the lth bias term of the second linear transformation in the sth encoder module during the (τ+1)th training iteration at time t,

$$\partial {J}^{τ} ( t ) / \partial {b}_{1}^{i , τ} ( t )$$

is the partial derivative of J^{τ}(t) with respect to

$${b}_{1}^{i , τ} ( t ) , \partial {J}^{τ} ( t ) / \partial {b}_{2 , s}^{l , τ} ( t )$$

is the partial derivative of J^{τ}(t) with respect to

$${b}_{2 , s}^{l , τ} ( t ) , \partial {J}^{τ} ( t ) / \partial {b}_{3 , s}^{l , τ} ( t )$$

is the partial derivative of J^{τ}(t) with respect to

$${b}_{3 , s}^{l , τ} ( t ) , \partial {J}^{τ} ( t ) / \partial {b}_{4}^{τ} ( t )$$

is the partial derivative of J^{τ}(t) with respect to

$${b}_{4}^{τ} ( t ) ,$$

τ=1, 2, . . . ,20;
\textcircled{4} if the training epoch τ<20, increment τ by 1 and return to step \textcircled{3} to continue training; if the training epoch τ≥20, terminate the model parameter training and proceed to step 4 for prediction;
4. predict the blower bearing temperature: using the trained blower bearing temperature prediction model, take as input the outlet air pressure data, drive-end bearing temperature of the high-speed shaft, vibration data of the high-speed shaft, inlet air temperature data, main motor current data, and historical bearing temperature of the blower's main motor collected at time t, obtain the model output ŷ(t) at time t according to equations (1)-(15), and use the model output as the predicted blower bearing temperature for the next time step following t, in degrees Celsius.
   The novelties of this patent contain:
(1) The present invention addresses the problem of prediction accuracy degradation caused by concept drift in the input variables during blower operation. A prediction method based on a spectral reconstructed neural network is proposed, in which a spectrum reconstruction layer is designed to perform frequency-domain feature extraction and smoothing on the input data. This alleviates the impact of concept drift on model performance and enables accurate prediction of the future state of blower bearing temperature.
(2) This invention designs a spectrum projection attention mechanism, where an approximately orthogonal projection matrix is used to decompose the query and key matrices within the attention mechanism. By adaptively adjusting the weights of different frequency features, the model's capability to recognize new and old operational patterns under concept drift is enhanced, thereby improving both the accuracy and stability of blower bearing temperature prediction.

### DESCRIPTION OF DRAWINGS

FIG. 1 shows the overall flow chart of the presented method.

FIG. 2 is the prediction result diagram of blower bearing temperature according to the method of the present invention.

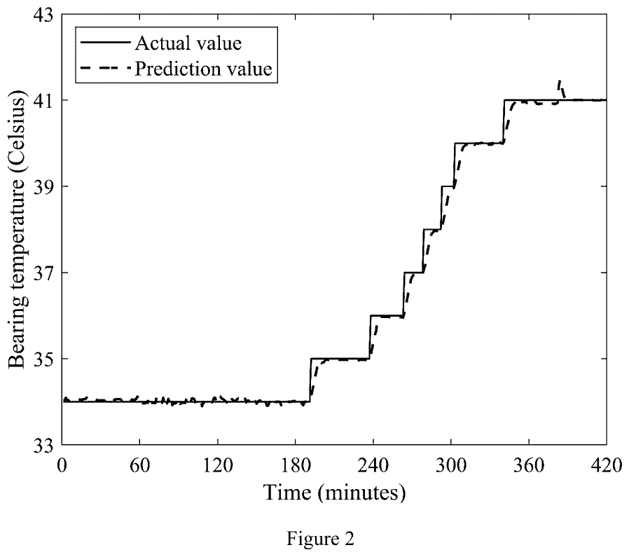

FIG. 3 is the prediction error diagram of blower bearing temperature according to the method of the present invention.

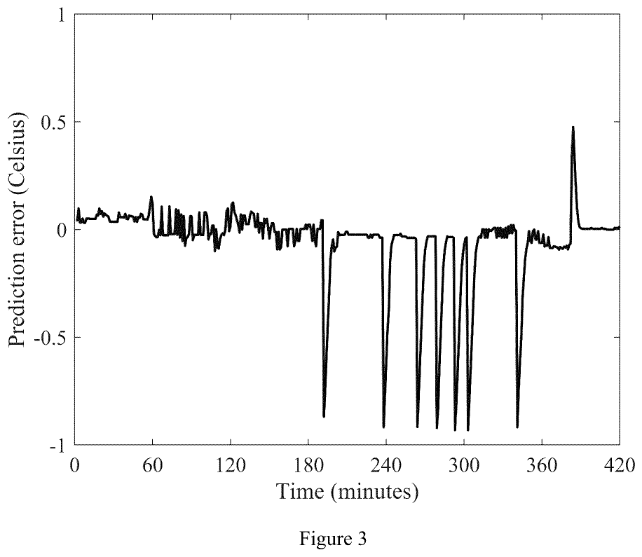

### DETAILED DESCRIPTION OF THE INVENTION

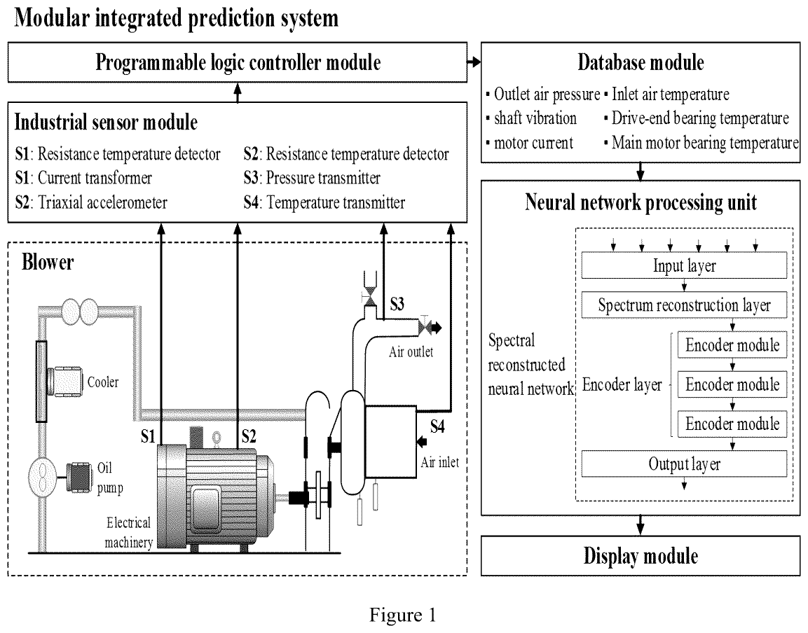

A prediction method for blower bearing temperature based on spectral reconstructed neural network, comprising the following device structure:
a modular integrated prediction system, comprising an industrial sensor module, a programmable logic controller module, a database module, a neural network processing unit, and a display module; the industrial sensor module comprises a pressure transmitter, a triaxial accelerometer, a temperature transmitter, a current transformer, and two resistance temperature detectors, the function of the industrial sensor module is to collect operational data of the blower system, including outlet air pressure, shaft vibration, inlet air temperature, motor current, drive-end bearing temperature, and main motor bearing temperature; the function of the programmable logic controller module is to receive signals from the industrial sensor module and transmit the collected data to the database module through an industrial communication protocol; the function of the database module is to store the time-series operational data for subsequent temperature prediction; the function of the neural network processing unit is to execute a spectral reconstructed neural network to predict blower bearing temperature based on the stored historical data; the function of the display module is to display the predicted temperature result;
the operational workflow of the modular integrated prediction system is as follows: first, operational data including outlet air pressure, shaft vibration, inlet air temperature, main motor current, drive-end bearing temperature, and main motor bearing temperature is continuously collected by the industrial sensor module from the blower system; second, the collected data is transmitted by the programmable logic controller module to the database module via an industrial communication protocol; third, the database module stores the incoming time-series data; fourth, the neural network processing unit accesses the historical operational data from the database module and performs blower main motor bearing temperature prediction using a spectral reconstructed neural network; finally, the predicted temperature result is visualized by the display module for real-time monitoring. The schematic diagram of the overall flow chart of the presented method is shown in FIG. 1.

The experimental data were collected from a real-world blower system operating in a municipal wastewater treatment plant, as detailed below: The input variables selected for the model include outlet air pressure, drive-end bearing temperature of the high-speed shaft, vibration amplitude of the high-speed shaft, inlet air temperature, main motor current, and the historical bearing temperature of the blower's main motor, with the output variable being the blower main motor bearing temperature. The experimental data were collected from a Howden blower operating in a municipal wastewater treatment plant. The data acquisition was performed using a Rosemount 3051 pressure transmitter, a WZPK-187 PT100 resistance temperature detector, an ENPAK VIB-100 triaxial accelerometer, a Honeywell T775U temperature transmitter, and a Schneider LC1D95 current transformer. The sampling cycle was set to 1 minute, and operational data including outlet air pressure, drive-end bearing temperature of the high-speed shaft, high-speed shaft vibration, inlet air temperature, main motor current, and main motor bearing temperature were continuously recorded. A total of 14 hours of data collection was performed, resulting in 840 sets of samples. The collected data were time-sequentially divided into a training set and a testing set, where the first 7 hours (420 samples) were used as the training set, and the remaining 7 hours (420 samples) were used as the testing set. The technical solution and implementation steps are as follows:
1. collect blower data: the input variables of the spectral reconstructed neural network include outlet air pressure, drive-end bearing temperature of the high-speed shaft, vibration amplitude of the high-speed shaft, inlet air temperature, main motor current, and the historical bearing temperature of the blower's main motor, the output variable is the predicted main motor bearing temperature of the blower; the main motor is a three-phase asynchronous motor configured to provide direct driving power to the blower system, with an output shaft connected to a high-speed shaft for driving the overall operation of the blower; the high-speed shaft is a high-speed rotating shaft segment configured to connect the output shaft of the main motor to an impeller transmission system, and used for transmitting rotational power from the motor to the blower; use a pressure transmitter installed on the outlet pipeline to collect the outlet air pressure data at time t as a vector x¹(t)=[x¹(t−L+1), . . . , x¹(t−1), x(t)], use a resistance temperature detector mounted on the bearing housing to collect the drive-end bearing temperature of the high-speed shaft at time t as a vector x²(t)=[x²(t−L+1), x²(t-x²(t)], use a triaxial accelerometer to collect the vibration data of the high-speed shaft at time t as a vector x³(t)=[x³(t−L+1), . . . , x³(t−1), x³(t)], use a temperature transmitter to collect the inlet air temperature at time t as a vector x⁴(t)=[x⁴(t−L+1), . . . , x⁴(t−1), x⁴(t)], use a current transformer to collect the main motor current at time t as a vector x⁵(t)=[x⁵(t−L+1), . . . , x⁵(t−1), x⁵(t)], use a resistance temperature detector to collect the historical bearing temperature of the blower's main motor at time t as a vector x⁶ (t)=[x⁶(t−L+1), . . . , x⁶(t−1), x⁶(t)], construct the input sample matrix at time t as X(t)=[x¹(t)^{T}, . . . , xⁿ(t)^{T}, . . . , x⁶(t)^{T}]^{T}, . . . , xⁿ(t)=[xⁿ(t−L+1), . . . , xⁿ(t−1), xⁿ(t)], n=1, 2, . . . , 6, t=L+1,L+2, . . . ,N+L+1, N is the number of sample sequences, L isg the number of time steps per input variable, and T represents matrix transposition;
2. establish a bearing temperature prediction model for blowers: construct a blower bearing temperature prediction model based on a spectral reconstructed neural network, wherein the spectral reconstructed neural network comprises an input layer, a spectrum reconstruction layer, a spectrum projection attention layer, and an output layer connected in sequence;
input layer: input the sample matrix into the model row by row, and the output of the input layer at time t is X(t)=[x¹(t)^{T}, x²(t)^{T}, x⁶(t)^{T}]T;
spectrum reconstruction layer: perform a real-valued discrete cosine transform on the input sample matrix, where each row of the input is mapped to a real-valued vector consisting of M frequency projection values, which is calculated as follows:

$${F}_{m}^{n} ( t ) = {\sum }_{k = 0}^{L - 1} {x}^{n} ( t - L + k + 1 ) \times cos ( \frac{6.28 m k}{L} ) where {F}_{m}^{n} ( t ) \qquad ( 19 )$$

is the mth frequency projection value of the nth row input sample at time t, cos(·) denotes the cosine function,

$${F}^{n} ( t ) = [ {F}_{1}^{n} ( t ) , … , {F}_{m}^{n} ( t ) , … , {F}_{M}^{n} ( t ) ] ,$$

Fⁿ(t) is the nth frequency projection vector of the input sample matrix at time t, and m=1, 2, . . . , M; apply smoothing to the frequency projection vector, and the smoothed frequency projection vector of the nth row is calculated as follows:

$${a}^{n} ( t ) = 0.9 {a}^{n} ( t - 1 ) + 0.1 ‖ {F}^{n} ( t ) - {F}^{n} ( t - 1 ) ‖ \qquad ( 20 )$$

$${b}^{n} ( t ) = 0.9 {b}^{n} ( t - 1 ) + 0.1 ( 1 - ‖ {F}^{n} ( t ) - {F}^{n} ( t - 1 ) ‖ ) \qquad ( 21 )$$

$${α}^{n} ( t ) = \frac{{a}^{n} ( t )}{{a}^{n} ( t ) + {b}^{n} ( t )} \qquad ( 22 )$$

$${\hat{F}}^{n} ( t ) = {a}^{n} ( t ) {F}^{n} ( t ) + ( 1 - {a}^{n} ( t ) ) {F}^{n} ( t - 1 ) , \qquad ( 23 )$$

where aⁿ(t) is the weighted cumulative value of the variation amplitude of the nth frequency projection vector at time t, in which the variation amplitude refers to the Euclidean distance between the current frequency projection vector and that of the previous time step, aⁿ(t−1) is the weighted cumulative value of the variation amplitude of the nth frequency projection vector at the previous time step t−1, Fⁿ(t−1) is the nth frequency projection vector of the input sample matrix at time t−1,

$${F}^{n} ( t - 1 ) = [ {F}_{1}^{n} ( t - 1 ) , … , {F}_{m}^{n} ( t - 1 ) , … , {F}_{M}^{n} ( t - 1 ) ] , {F}_{m}^{n} ( t - 1 )$$

is the mth frequency projection value of the nth row in the input sample matrix at the previous time t−1, ∥·∥ denotes the Euclidean norm of a vector, bⁿ(t) is the weighted cumulative value of the stability of variation for the nth frequency projection vector at time t, where the stability of variation refers to the difference between 1 and the Euclidean distance between the current frequency projection vector and that of the previous time step, bⁿ(t−1) is the weighted cumulative value of the stability of variation for the nth frequency projection vector at the previous time t−1, \hat{F}ⁿ(t) is the nth smoothed frequency projection vector,

$${\hat{F}}^{n} ( t ) = [ {\hat{F}}_{1}^{n} ( t ) , … , {\hat{F}}_{m}^{n} ( t ) , … , {\hat{F}}_{M}^{n} ( t ) ] , {\hat{F}}_{m}^{n} ( t )$$

is the mth smoothed frequency projection value of the nth row input sample at time t, αⁿ(t) is the smoothing coefficient corresponding to the nth frequency projection vector, α(t)=[α¹(t),α²(t), . . . ,α⁶(t)]^{T}, α(t) is the smoothing coefficient vector at time t; combine the smoothed frequency projection vectors to form a frequency embedding matrix, and perform a linear transformation on the frequency embedding matrix to obtain the token representation matrix, calculated as follows:

Z₁(t)=E(t)W₁(t)+b₁(t) (24)

where E(t) is the frequency embedding matrix at time t, E(t)=[\hat{F}¹(t)^{T},\hat{F}²(t)^{T}, . . . ,\hat{F}⁶(t)^{T}], and Z₁(t) is the token representation matrix at time t,

$${Z}_{1} ( t ) = {[ {{Z}_{1}^{1} ( t )}^{T} , … , {{Z}_{1}^{m} ( t )}^{T} , … , {{Z}_{1}^{M} ( t )}^{T} ]}^{T} , {Z}_{1}^{m} ( t )$$

is the mth row vector of the token representation matrix,

$${Z}_{1}^{m} ( t ) = [ {Z}_{1}^{m , 1} ( t ) , … , {Z}_{1}^{m , i} ( t ) , … , {Z}_{1}^{m , D} ( t ) ] , {Z}_{1}^{m , i} ( t )$$

is the element in the ith column of the mth row of the token representation matrix, W₁(t) is the frequency embedding weight matrix at time t,

$${W}_{1} ( t ) = {[ {{W}_{1}^{1} ( t )}^{T} , … , {{W}_{1}^{n} ( t )}^{T} , … , {{W}_{1}^{6} ( t )}^{T} ]}^{T} , {W}_{1}^{n} ( t )$$

is the nth row vector of the frequency embedding weight matrix,

$${W}_{1}^{n} ( t ) = [ {W}_{1}^{n , 1} ( t ) , … , {W}_{1}^{n , i} ( t ) , … , {W}_{1}^{n , D} ( t ) ] , {W}_{1}^{n , i} ( t )$$

is the element in the ith column of the nth row of the frequency embedding weight matrix, b₁(t) is the frequency embedding bias vector at time t,

$${b}_{1} ( t ) = [ {b}_{1}^{1} ( t ) , … , {b}_{1}^{i} ( t ) , … , {b}_{1}^{D} ( t ) ] , {b}_{1}^{i} ( t )$$

is the ith frequency embedding bias term, D is the embedding dimension of the token representation, and i=1, 2, . . . , D;
encoder layer: consists of three stacked encoder modules, where s=1,2,3 indicates the index of the sth encoder module, each encoder module sequentially performs frequency projection attention, residual connection, layer normalization, feedforward transformation, another residual connection, and layer normalization on the input token representation matrix, the frequency projection attention operation constructs a frequency projection matrix, which is designed to partition the attention representation into subspaces of new and old patterns, thereby enhancing the model's adaptability to concept drift, the frequency projection matrix is calculated as follows:

P(t)=E(t)a(t)diag (Z₁(t)^{T}Z₁(t))^{T} (25)

where P(t) is the frequency projection matrix at time t, P(t)=[P¹(t)^{T}, . . . , P^{m}(t)^{T}, . . . , P^{m} (t)^{T}, . . . , P^{M}(t)^{T}]^{T}, is the mth row vector of the first frequency projection matrix at time t, P^{m}(t)=[P^{m,1} (t), . . . , P^{m,j} (t), . . . , P^{m,M} (t)], p^{m,j} (t) is the element in the jth column of the mth row of the frequency projection matrix at time t, diag(⋅) extracts the diagonal elements of a matrix and outputs them as a column vector, j=1, 2, . . . , M; the query matrix, key matrix, and value matrix of the sth encoder module are calculated as follows:

Qₛ(t)=Zₛ(t)W_{Q,s}(t) (26)

Kₛ(t)=Zₛ(t)W_{K,s}(t) (27)

Vₛ(t)=Zₛ(t)W_{V,s}(t) (28)

where Qₛ(t) is the query matrix of the sth encoder module at time t,

$${Q}_{s} ( t ) = {[ {{Q}_{s}^{1} ( t )}^{T} , … , {{Q}_{s}^{m} ( t )}^{T} , … , {{Q}_{s}^{M} ( t )}^{T} ]}^{T} , {Q}_{s}^{m} ( t )$$

is the mth row vector of the query matrix of the sth encoder module,

$${Q}_{s}^{m} ( t ) = [ {Q}_{s}^{m , 1} ( t ) , … , {Q}_{s}^{m , i} ( t ) , … , {Q}_{s}^{m , D} ( t ) ] , {Q}_{s}^{m , i} ( t )$$

is the element in the ith column of the mth row of the query matrix of the sth encoder module, W_{Q,s}(t) is the query weight matrix of the sth encoder module at time t,

$${W}_{Q , s} ( t ) = {[ {{W}_{Q , s}^{1} ( t )}^{T} , … , {{W}_{Q , s}^{i} ( t )}^{T} , … , {{W}_{Q , s}^{64} ( t )}^{T} ]}^{T} , {W}_{Q , s}^{i} ( t )$$

is the ith row vector of the query weight matrix of the sth encoder module at time t,

$${W}_{Q , s}^{i} ( t ) = [ {W}_{Q , s}^{i , 1} ( t ) , … , {W}_{Q , s}^{i , l} ( t ) , … , {W}_{Q , s}^{i , D} ( t ) ] , {W}_{Q , s}^{i , l} ( t )$$

is the element in the lth column of the ith row of the query weight matrix of the sth encoder module at time t, Kₛ(t) is the key matrix of the sth encoder module at time t,

$${K}_{s} ( t ) = {[ {{K}_{s}^{1} ( t )}^{T} , … , {{K}_{s}^{m} ( t )}^{T} , … , {{K}_{s}^{M} ( t )}^{T} ]}^{T} , {K}_{s}^{m} ( t )$$

is the element in the ith column of the mth row of the key matrix of the sth encoder module at time t,

$${K}_{s}^{m} ( t ) = [ {K}_{s}^{m , 1} ( t ) , … , {K}_{s}^{m , i} ( t ) , … , {K}_{s}^{m , D} ( t ) ] , {K}_{s}^{m , i} ( t )$$

is the element in the ith column of the mth row of the key matrix of the sth encoder module at time t, W_{K,s} (t) is the key weight matrix of the sth encoder module at time t,

$${W}_{K , s} ( t ) = {[ {{W}_{K , s}^{1} ( t )}^{T} , … , {{W}_{K , s}^{i} ( t )}^{T} , … , {{W}_{K , s}^{D} ( t )}^{T} ]}^{T} , {W}_{K , s}^{m} ( t )$$

is the ith row vector of the key weight matrix of the sth encoder module at time t,

$${W}_{K , s}^{i} ( t ) = [ {W}_{K , s}^{i , 1} ( t ) , … , {W}_{K , s}^{i , l} ( t ) , … , {W}_{K , s}^{i , 64} ( t ) ] , {W}_{K , s}^{i , l} ( t )$$

is the element in the lth column of the ith row of the key weight matrix of the sth encoder module at time t, Vₛ(t) is the value matrix of the sth encoder module at time t,

$${V}_{s} ( t ) = {[ {{V}_{s}^{1} ( t )}^{T} , … , {{V}_{s}^{m} ( t )}^{T} , … , {{V}_{s}^{M} ( t )}^{T} ]}^{T} , {V}_{s}^{m} ( t )$$

is the mth row vector of the value matrix of the sth encoder module at time t,

$${V}_{s}^{m} ( t ) = [ {V}_{s}^{m , 1} ( t ) , … , {V}_{s}^{m , i} ( t ) , … , {V}_{s}^{m , D} ( t ) ] , {V}_{s}^{m , i} ( t )$$

is the element in the ith column of the mth row of the value matrix of the sth encoder module at time t, W_{V,s}(t) is the value weight matrix of the sth encoder module at time t,

$${W}_{V , s} ( t ) = {[ {{W}_{V , s}^{1} ( t )}^{T} , … , {{W}_{V , s}^{i} ( t )}^{T} , … , {{W}_{V , s}^{D} ( t )}^{T} ]}^{T} , {W}_{V , s}^{i} ( t )$$

is the ith row vector of the value weight matrix of the sth encoder module at time t,

$${W}_{V , s}^{i} ( t ) = [ {W}_{V , s}^{i , 1} ( t ) , … , {W}_{V , s}^{i , l} ( t ) , … , {W}_{V , s}^{i , D} ( t ) ] , {W}_{V , s}^{i , l} ( t )$$

is the element in the lth column of the ith row of the value weight matrix of the sth encoder module at time t, and i=1, 2, . . . , D; the output of the frequency projection attention is calculated as follows:

A_{1,S}(t)=softmax(P(t)Qₛ(t)Kₛ(t)^{T}P(t)^{T}) (29)

A_{2,s}(t)=softmax ((I−P(t))Qₛ(t)Kₛ(t)^{T}(I−P(t))^{T}) (30)

O_{S}(t)=(A_{1,S}(t)+A_{2,S}(t))V_{S}(t) (31)

where A_{1,s}(t) is the first attention matrix of the sth encoder module at time t,

$${A}_{1 , s} ( t ) = {[ {{A}_{1 , s}^{1} ( t )}^{T} , … , {{A}_{1 , s}^{m} ( t )}^{T} , … , {{A}_{1 , s}^{M} ( t )}^{T} ]}^{T} , {A}_{1 , s}^{m} ( t )$$

is the mth row vector of the first attention matrix of the sth encoder module at time t,

$${A}_{1 , s}^{m} ( t ) = [ {A}_{1 , s}^{m , 1} ( t ) , … , {A}_{1 , s}^{m , j} ( t ) , … , {A}_{1 , s}^{m , M} ( t ) ] , {A}_{1 , s}^{m , j} ( t )$$

is the element in the jth column of the mth row of the first attention matrix of the sth encoder module at time t, I is the identity matrix, A_{2,s}(t) is the second attention matrix of the sth encoder module at time t,

$${A}_{2 , s} ( t ) = {[ {{A}_{2 , s}^{1} ( t )}^{T} , … , {{A}_{2 , s}^{m} ( t )}^{T} , … , {{A}_{2 , s}^{M} ( t )}^{T} ]}^{T} , {A}_{2 , s}^{m} ( t )$$

is the mth row vector of the second attention matrix of the sth encoder module at time t,

$${A}_{2 , s}^{m} ( t ) = [ {A}_{2 , s}^{m , 1} ( t ) , … , {A}_{2 , s}^{m , j} ( t ) , … , {A}_{2 , s}^{m , M} ( t ) ] , {A}_{2 , s}^{m , j} ( t )$$

is the element in the jth column of the mth row of the second attention matrix of the sth encoder module at time t, softmax(⋅) denotes the row-wise normalization of the input matrix such that the sum of each row is equal to 1, Oₛ(t) is the attention output matrix of the sth encoder module at time t,

$${O}_{s} ( t ) = {[ {{O}_{s}^{1} ( t )}^{T} , … , {{O}_{s}^{m} ( t )}^{T} , … , {{O}_{s}^{M} ( t )}^{T} ]}^{T} , {O}_{s}^{m} ( t )$$

is the mth row vector of the attention output matrix of the sth encoder module at time t,

$${O}_{s}^{m} ( t ) = [ {O}_{s}^{m , 1} ( t ) , … , {O}_{s}^{m , i} ( t ) , … , {O}_{s}^{m , D} ( t ) ] , {O}_{s}^{m , i} ( t )$$

is the element in the ith column of the mth row of the attention output matrix of the sth encoder module at time t, perform a residual connection operation and a layer normalization operation on the attention output matrix Oₛ(t) to obtain the residual updated output matrix of the sth encoder module Rₛ(t),

$${R}_{s} ( t ) = {[ {{R}_{s}^{1} ( t )}^{T} , … , {{R}_{s}^{m} ( t )}^{T} , … , {{R}_{s}^{M} ( t )}^{T} ]}^{T} , {R}_{s}^{m} ( t )$$

is the mth row vector of the residual updated output matrix of the sth encoder module at time t,

$${R}_{s}^{m} ( t ) = [ {R}_{s}^{m , 1} ( t ) , … , {R}_{s}^{m , i} ( t ) , … , {R}_{s}^{m , D} ( t ) ] , {R}_{s}^{m , i} ( t )$$

is the element in the ith column of the mth row of the residual updated output matrix of the sth encoder module at time t; feed the residual updated matrix into a feedforward neural network, the feedforward neural network consists of a first linear transformation layer with input dimension D and output dimension D, and a second linear transformation layer with input dimension D and output dimension D, with a nonlinear activation layer connected between them, the nonlinear activation function is a rectified linear unit (ReLU), which is used for dimensional reconstruction and feature mapping of the token representation vectors, where the dimension D is equal to the embedding dimension of the token representation; the feedforward output of the sth encoder module is calculated as follows:

\tilde{R}ₛ(t)=ReLU(Rₛ(t)·W_{2,s}(t)+b_{2,s}(t))W_{3,s}(t)+b_{3,s}(t) (32)

where \tilde{R}ₛ(t) is the feedforward output matrix of the sth encoder module at time t,

$${\tilde{R}}_{s} ( t ) = {[ {{\tilde{R}}_{s}^{1} ( t )}^{T} , … , {{\tilde{R}}_{s}^{m} ( t )}^{T} , … , {{\tilde{R}}_{s}^{M} ( t )}^{T} ]}^{T}$$

is the mth row vector of the feedforward output matrix of the sth encoder module at time t,

$${\tilde{R}}_{s}^{m} ( t ) = [ {\tilde{R}}_{s}^{m , 1} ( t ) , … , {\tilde{R}}_{s}^{m , i} ( t ) , … , {\tilde{R}}_{s}^{m , D} ( t ) ] , {\tilde{R}}_{s}^{m , i} ( t )$$

is the element in the ith column of the mth row of the feedforward output matrix of the sth encoder module at time t, ReLU(⋅) is the rectified linear unit activation function, W_{2,s}(t) is the first linear transformation weight matrix of the sth encoder module at time t,

$${W}_{2 , s} ( t ) = {[ {{W}_{2 , s}^{1} ( t )}^{T} , … , {{W}_{2 , s}^{i} ( t )}^{T} , … , {{W}_{2 , s}^{D} ( t )}^{T} ]}^{T} , {W}_{2 , s}^{i} ( t )$$

is the ith row vector of the first linear transformation weight matrix of the sth encoder module at time t,

$${W}_{2 , s}^{i} ( t ) = [ {W}_{2 , s}^{i , 1} ( t ) , … , {W}_{2 , s}^{i , l} ( t ) , … , {W}_{2 , s}^{i , D} ( t ) ] , {W}_{2 , s}^{i , l} ( t )$$

is the element in the lth column of the ith row of the first linear transformation weight matrix of the sth encoder module at time t, b_{2,s} (t) is the first linear transformation bias vector of the sth encoder module at time t,

$${b}_{2 , s} ( t ) = [ {b}_{2 , s}^{1} ( t ) , … , {b}_{2 , s}^{l} ( t ) , … , {b}_{2 , s}^{D} ( t ) ] , {b}_{2 , s}^{l} ( t )$$

is the lth element of the first linear transformation bias vector of the sth encoder module at time t, W_{3,s} (t) is the second linear transformation weight matrix of the sth encoder module at time t,

$${W}_{3 , s} ( t ) = {[ {{W}_{3 , s}^{1} ( t )}^{T} , … , {{W}_{3 , s}^{i} ( t )}^{T} , … , {{W}_{3 , s}^{D} ( t )}^{T} ]}^{T} , {W}_{3 , s}^{i} ( t )$$

is the ith row vector of the second linear transformation weight matrix of the sth encoder module at time t,

$${W}_{3 , s}^{i} ( t ) = [ {W}_{3 , s}^{i , 1} ( t ) , … , {W}_{3 , s}^{i , l} ( t ) , … , {W}_{3 , s}^{i , D} ( t ) ] , {W}_{3 , s}^{i , l} ( t )$$

is the element in the lth column of the ith row of the second linear transformation weight matrix of the sth encoder module at time t, b_{3,s} (t) is the second linear transformation bias vector of the sth encoder module at time t,

$${b}_{3 , s} ( t ) = [ {b}_{3 , s}^{1} ( t ) , … , {b}_{3 , s}^{l} ( t ) , … , {b}_{3 , s}^{D} ( t ) ] , {b}_{3 , s}^{l} ( t )$$

is the lth element of the second linear transformation bias vector of the sth encoder module at time t, perform a residual connection operation and a layer normalization operation on the feedforward output matrix of the sth encoder module \tilde{R}ₛ(t) to obtain the token representation matrix output by the sth encoder module Zₛ₊₁(t) at time t,

$${Z}_{s + 1} ( t ) = {[ {{Z}_{s + 1}^{1} ( t )}^{T} , … , {{Z}_{s + 1}^{m} ( t )}^{T} , … , {{Z}_{s + 1}^{M} ( t )}^{T} ]}^{T} , {Z}_{s + 1}^{m} ( t )$$

is the mth row vector of the token representation matrix output by the sth encoder module at time t,

$${Z}_{s + 1}^{m} ( t ) = [ {Z}_{s + 1}^{m , 1} ( t ) , … , {Z}_{s + 1}^{m , i} ( t ) , … , {Z}_{s + 1}^{m , D} ( t ) ] , {Z}_{s + 1}^{m , i} ( t ) is$$

the element in the ith column of the mth row of the token representation matrix output by the sth encoder module at time t;
output layer: apply a linear regression layer to map the token representation matrix output by the third encoder module to the final output of the model, and the model output is calculated as follows:

ŷ(t)=Z₄(t)W₄(t)+b₄(t) (33)

where ŷ(t) is the predicted output value of the main motor bearing temperature at time t, in degrees Celsius, W₄(t) is the weight vector of the linear regression layer in the output layer at time t,

$${W}_{4} ( t ) = {[ {W}_{4}^{1} ( t ) , … , {W}_{4}^{i} ( t ) , … , {W}_{4}^{D} ( t ) ]}^{T} , {W}_{4}^{j} ( t )$$

is the ith element of the linear regression weight vector at time t, b₄(t) is the bias term of the linear regression layer;
3. train the parameters of the blower bearing temperature prediction model:
\textcircled{1} define the loss function of the model as:

$$J ( t ) = \frac{1}{2} {( \hat{y} ( t ) - y ( t ) )}^{2} \qquad ( 34 )$$

where J(t) is the loss of the model at time t, y(t) is the actual measured main motor bearing temperature at time t, in degrees Celsius, which is used as a supervision signal for model training;
\textcircled{2} set the current training time to t, initialize the training epoch counter τ=1, and fix the number of training iterations to 20; initialize the model's weight parameters and bias parameters, where the weight parameters are randomly initialized within the range [−0.2, 0.2], and the bias parameters are initialized to 0;
\textcircled{3} compute the actual output of the model at time t during the τth training iteration ŷ^{τ}(t) using equations (19)-(33), compute the loss of the model at time t during the τth training iteration J^{τ}(t) using equation (34), and update the weight matrices and bias vectors using the gradient descent method, with the update formulas given as follows:

$$\{ \begin{matrix}{W}_{1}^{n , i , τ + 1} ( t ) = {W}_{1}^{n , i , τ} ( t ) + 0.01 \cdot \partial {J}^{τ} ( t ) / \partial {W}_{1}^{n , i , τ} ( t ) \\ {W}_{Q , s}^{i , l , τ + 1} ( t ) = {W}_{Q , s}^{i , l , τ} ( t ) + 0 \text{.01} \cdot \partial {J}^{τ} ( t ) / \partial {W}_{Q , s}^{i , l , τ} ( t ) \\ {W}_{K , s}^{i , l , τ + 1} ( t ) = {W}_{K , s}^{i , l , τ} ( t ) + 0 \text{.01} \cdot \partial {J}^{τ} ( t ) / \partial {W}_{K , s}^{i , l , τ} ( t ) \\ {W}_{V , s}^{i , l , τ + 1} ( t ) = {W}_{V , s}^{i , l , τ} ( t ) + 0 \text{.01} \cdot \partial {J}^{τ} ( t ) / \partial {W}_{V , s}^{i , l , τ} ( t ) \\ {W}_{2 , s}^{i , l , τ + 1} ( t ) = {W}_{2 , s}^{i , l , τ} ( t ) + 0 \text{.01} \cdot \partial {J}^{τ} ( t ) / \partial {W}_{2 , s}^{i , l , τ} ( t ) \\ {W}_{3 , s}^{i , l , τ + 1} ( t ) = {W}_{3 , s}^{i , l , τ} ( t ) + 0 \text{.01} \cdot \partial {J}^{τ} ( t ) / \partial {W}_{3 , s}^{i , l , τ} ( t ) \\ {W}_{4}^{i , τ + 1} ( t ) = {W}_{4}^{i , τ} ( t ) + 0 \text{.01} \cdot \partial {J}^{τ} ( t ) / \partial {W}_{4}^{i , τ} ( t )\end{matrix} \qquad ( 35 )$$

$$\{ \begin{matrix}{b}_{1}^{i , τ + 1} ( t ) = {b}_{1}^{i , τ} ( t ) + 0 \text{.01} \cdot \partial {J}^{τ} ( t ) / \partial {b}_{1}^{i , τ} ( t ) \\ {b}_{2 , s}^{l , τ + 1} ( t ) = {b}_{2 , s}^{l , τ} ( t ) + 0 \text{.01} \cdot \partial {J}^{τ} ( t ) / \partial {b}_{2 , s}^{l , τ} ( t ) \\ {b}_{3 , s}^{l , τ + 1} ( t ) = {b}_{3 , s}^{l , τ} ( t ) + 0 \text{.01} \cdot \partial {J}^{τ} ( t ) / \partial {b}_{3 , s}^{l , τ} ( t ) \\ {b}_{4}^{τ + 1} ( t ) = {b}_{4}^{τ} ( t ) + 0 \text{.01} \cdot \partial {J}^{τ} ( t ) / \partial {b}_{4}^{τ} ( t )\end{matrix} \qquad ( 36 )$$

$$where {W}_{1}^{n , i , τ} ( t )$$

is the coefficient at the ith column of the nth row of the frequency embedding weight matrix during the τth training iteration at time t,

$${W}_{Q , s}^{i , l , τ} ( t )$$

is the coefficient at the lth column of the ith row of the sth query weight matrix during the τth training iteration at time t,

$${W}_{K , s}^{i , l , τ} ( t )$$

is the coefficient at the ith column of the mth row of the sth key weight matrix during the τth training iteration at time t,

$${W}_{V , s}^{i , l , τ} ( t )$$

is the coefficient at the ith column of the mth row of the sth value weight matrix during the τth training iteration at time t,

$${W}_{2 , s}^{i , l , τ} ( t )$$

is the coefficient at the lth column of the ith row of the first linear transformation weight matrix of the sth encoder module during the τth training iteration at time t,

$${W}_{3 , s}^{i , l , τ} ( t )$$

is the coefficient at the lth column of the ith row of the second linear transformation weight matrix of the sth encoder module during the τth training iteration at time t,

$${W}_{4}^{i , τ} ( t )$$

is the ith coefficient of the linear regression weight vector in the output layer during the τth training iteration at time t,

$${W}_{1}^{n , i , τ + 1} ( t )$$

is the coefficient at the ith column of the nth row of the frequency embedding weight matrix during the (τ+1)th training iteration at time t,

$${W}_{Q , s}^{i , l , τ + 1} ( t )$$

is the coefficient at the lth column of the ith row of the sth query weight matrix during the (τ+1)th training iteration at time t,

$${W}_{K , s}^{i , l , τ + 1} ( t )$$

is the coefficient at the ith column of the mth row of the sth key weight matrix during the (τ+1)th training iteration at time t,

$${W}_{V , s}^{i , l , τ + 1} ( t )$$

is the coefficient at the ith column of the mth row of the sth value weight matrix during the (τ+1)th training iteration at time t,

$${W}_{2 , s}^{i , l , τ + 1} ( t )$$

is the coefficient at the lth column of the ith row of the first linear transformation weight matrix of the sth encoder module during the (τ+1)th training iteration at time t,

$${W}_{3 , s}^{i , l , τ + 1} ( t )$$

is the coefficient at the lth column of the ith row of the second linear transformation weight matrix of the sth encoder module during the (τ+1)th training iteration at time t,

$${W}_{4}^{i , τ + 1} ( t )$$

is the ith coefficient of the linear regression weight vector in the output layer during the (τ+1)th training iteration at time t,

$$\partial {J}^{τ} ( t ) / \partial {W}_{1}^{n , i , τ} ( t )$$

is the partial derivative of J^{τ}(t) with respect to

$${W}_{1}^{n , i , τ} ( t ) , \partial {J}^{τ} ( t ) / \partial {W}_{Q , s}^{i , l , τ} ( t )$$

is the partial derivative of J^{τ}(t) with respect to

$${W}_{Q , s}^{i , l , τ} ( t ) , \partial {J}^{τ} ( t ) / \partial {W}_{K , s}^{i , l , τ} ( t )$$

is the partial derivative of J^{τ}(t) with respect to

$${W}_{K , s}^{i , l , τ} ( t ) , \partial {J}^{τ} ( t ) / \partial {W}_{V , s}^{i , l , τ} ( t )$$

is the partial derivative of J^{τ}(t) with respect to

$${W}_{V , s}^{i , l , τ} ( t ) , \partial {J}^{τ} ( t ) / \partial {W}_{2 , s}^{i , l , τ} ( t )$$

is the partial derivative of J^{τ}(t) with respect to

$${W}_{2 , s}^{i , l , τ} ( t ) , \partial {J}^{τ} ( t ) / \partial {W}_{3 , s}^{i , l , τ} ( t )$$

is the partial derivative of J^{τ}(t) with respect to

$${W}_{3 , s}^{i , l , τ} ( t ) , \partial {J}^{τ} ( t ) / \partial {W}_{4}^{i , τ} ( t )$$

is the partial derivative of J^{τ}(t) with respect to

$${W}_{4}^{i , τ} ( t ) , {b}_{1}^{i , τ} ( t )$$

is the ith frequency embedding bias term during the τth training iteration at time t,

$${b}_{2 , s}^{i , τ} ( t )$$

is the lth bias term of the first linear transformation in the sth encoder module during the τth training iteration at time t,

$${b}_{3 , s}^{i , τ} ( t )$$

is the lth bias term of the second linear transformation in the sth encoder module during the τth training iteration at time t,

$${b}_{4}^{τ} ( t )$$

is the lth bias term of the second linear transformation in the sth encoder module during the τth training iteration at time t,

$${b}_{1}^{i , τ + 1} ( t )$$

is the ith frequency embedding bias term during the (τ+1)th training iteration at time t,

$${b}_{2 , s}^{i , τ + 1} ( t )$$

is the lth bias term of the first linear transformation in the sth encoder module during the (τ+1)th training iteration at time t,

$${b}_{3 , s}^{i , τ + 1} ( t )$$

is the lth bias term of the second linear transformation in the sth encoder module during the (τ+1)th training iteration at time t,

$${b}_{4}^{τ + 1} ( t )$$

is the lth bias term of the second linear transformation in the sth encoder module during the (τ+1)th training iteration at time t,

$$\partial {J}^{τ} ( t ) / \partial {b}_{1}^{i , τ} ( t )$$

is the partial derivative of J^{τ}(t) with respect to

$${b}_{1}^{i , τ} ( t ) , \partial {J}^{τ} ( t ) / \partial {b}_{2 , s}^{l , τ} ( t )$$

is the partial derivative of J^{τ}(t) with respect to

$${b}_{2 , s}^{l , τ} ( t ) , \partial {J}^{τ} ( t ) / \partial {b}_{3 , s}^{l , τ} ( t )$$

is the partial derivative of J^{τ}(t) with respect to

$${b}_{3 , s}^{l , τ} ( t ) , \partial {J}^{τ} ( t ) / \partial {b}_{4}^{τ} ( t )$$

is the partial derivative of J^{τ}(t) with respect to

$${b}_{4}^{τ} ( t ) ,$$

τ=1, 2, . . . ,20;
\textcircled{4} if the training epoch τ<20, increment τ by 1 and return to step \textcircled{3} to continue training; if the training epoch τ≥20, terminate the model parameter training and proceed to step 4 for prediction;
4. predict the blower bearing temperature: using the trained blower bearing temperature prediction model, take as input the outlet air pressure data, drive-end bearing temperature of the high-speed shaft, vibration data of the high-speed shaft, inlet air temperature data, main motor current data, and historical bearing temperature of the blower's main motor collected at time t, obtain the model output ŷ(t) at time t according to equations (19)-(33), and use the model output as the predicted blower bearing temperature for the next time step following t, in degrees Celsius.

What is claimed is:

1. A prediction method for blower bearing temperature based on spectral reconstructed neural network, comprising the following device structure:
a modular integrated prediction system, comprising an industrial sensor module, a programmable logic controller module, a database module, a neural network computing unit, and a display module; the industrial sensor module comprises a pressure transmitter, a triaxial accelerometer, a temperature transmitter, a current transformer, and two resistance temperature detectors, the function of the industrial sensor module is to collect operational data of the blower system, including outlet air pressure, shaft vibration, inlet air temperature, motor current, drive-end bearing temperature, and main motor bearing temperature; the function of the programmable logic controller module is to receive signals from the industrial sensor module and transmit the collected data to the database module through an industrial communication protocol; the function of the database module is to store the time-series operational data for subsequent temperature prediction; the function of the neural network computing unit is to execute a spectral reconstructed neural network to predict blower bearing temperature based on the stored historical data; the function of the display module is to display the predicted temperature result;
the operational workflow of the modular integrated prediction system is as follows: first, operational data including outlet air pressure, shaft vibration, inlet air temperature, main motor current, drive-end bearing temperature, and main motor bearing temperature is continuously collected by the industrial sensor module from the blower system; second, the collected data is transmitted by the programmable logic controller module to the database module via an industrial communication protocol; third, the database module stores the incoming time-series data; fourth, the neural network computing unit accesses the historical operational data from the database module and performs blower main motor bearing temperature prediction using a spectral reconstructed neural network; finally, the predicted temperature result is visualized by the display module for real-time monitoring, with the specific prediction method as follows:
(1) collect blower data: the input variables of the spectral reconstructed neural network include outlet air pressure, drive-end bearing temperature of the high-speed shaft, vibration amplitude of the high-speed shaft, inlet air temperature, main motor current, and the historical bearing temperature of the blower's main motor, the output variable is the predicted main motor bearing temperature of the blower; the main motor is a three-phase asynchronous motor configured to provide direct driving power to the blower system, with an output shaft connected to a high-speed shaft for driving the overall operation of the blower; the high-speed shaft is a high-speed rotating shaft segment configured to connect the output shaft of the main motor to an impeller transmission system, and used for transmitting rotational power from the motor to the blower; use a pressure transmitter installed on the outlet pipeline to collect the outlet air pressure data at time t as a vector x¹(t)=[x¹(t−L+1), . . . , x¹(t−1), x¹(t)], use a resistance temperature detector mounted on the bearing housing to collect the drive-end bearing temperature of the high-speed shaft at time t as a vector x²(t)=[x²(t−L+1), . . . , x²(t−1), x²(t)], use a triaxial accelerometer to collect the vibration data of the high-speed shaft at time t as a vector x³(t)=[x³(t−L+1), . . . , x³(t−1), x³(t)], use a temperature transmitter to collect the inlet air temperature at time t as a vector x⁴(t)=[x⁴(t−L+1), . . . , x⁴(t−1), x⁴(t)], use a current transformer to collect the main motor current at time t as a vector x⁵(t)=[x⁵(t−L+1), . . . , x⁵(t−1), x⁵(t)], use a resistance temperature detector to collect the historical bearing temperature of the blower's main motor at time t as a vector x⁶ (t)=[x⁶(t−L+1), . . . , x⁶(t−1), x⁶(t)], construct the input sample matrix at time t as X(t)=[x¹(t)^{T}, . . . , xⁿ(t)^{T}, . . . , x⁶(t)^{T}]^{T}, xⁿ(t)=[xⁿ(t)=[xⁿ(t−L+1), . . . , xⁿ(t−1), xⁿ(t)], n=1, 2, . . . , 6, t=L+1,L+2, . . . ,N+L+1, Nis the number of sample sequences, L isg the number of time steps per input variable, and T represents matrix transposition;
(2) establish a bearing temperature prediction model for blowers: construct a blower bearing temperature prediction model based on a spectral reconstructed neural network, wherein the spectral reconstructed neural network comprises an input layer, a spectrum reconstruction layer, a spectrum projection attention layer, and an output layer connected in sequence;
input layer: input the sample matrix into the model row by row, and the output of the input layer at time t is X(t)=[x¹(t)^{T}, x²(t)^{T}, . . . , x⁶(t)^{T}]^{T};
spectrum reconstruction layer: perform a real-valued discrete cosine transform on the input sample matrix, where each row of the input is mapped to a real-valued vector consisting of M frequency projection values, which is calculated as follows:
$${F}_{m}^{n} ( t ) = {\sum }_{k = 0}^{L - 1} {x}^{n} ( t - L + k + 1 ) \times cos ( \frac{6.28 m k}{L} ) where {F}_{m}^{n} ( t ) \qquad ( 1 )$$
is the mth frequency projection value of the nth row input sample at time t, cos(⋅) denotes the cosine function,
$${F}^{n} ( t ) = [ {F}_{1}^{n} ( t ) , … , {F}_{m}^{n} ( t ) , … , {F}_{M}^{n} ( t ) ] ,$$
Fⁿ(t) is the nth frequency projection vector of the input sample matrix at time t, and m=1, 2, . . . , M; apply smoothing to the frequency projection vector, and the smoothed frequency projection vector of the nth row is calculated as follows:
$${a}^{n} ( t ) = 0.9 {a}^{n} ( t - 1 ) + 0.1 ‖ {F}^{n} ( t ) - {F}^{n} ( t - 1 ) ‖ \qquad ( 2 )$$
$${b}^{n} ( t ) = 0.9 {b}^{n} ( t - 1 ) + 0.1 ( 1 - ‖ {F}^{n} ( t ) - {F}^{n} ( t - 1 ) ‖ ) \qquad ( 3 )$$
$${α}^{n} ( t ) = \frac{{a}^{n} ( t )}{{a}^{n} ( t ) + {b}^{n} ( t )} \qquad ( 4 )$$
$${\hat{F}}^{n} ( t ) = {α}^{n} ( t ) {F}^{n} ( t ) + ( 1 - {α}^{n} ( t ) ) {F}^{n} ( t - 1 ) , \qquad ( 5 )$$
where aⁿ(t) is the weighted cumulative value of the variation amplitude of the nth frequency projection vector at time t, in which the variation amplitude refers to the Euclidean distance between the current frequency projection vector and that of the previous time step, aⁿ(t−1) is the weighted cumulative value of the variation amplitude of the nth frequency projection vector at the previous time step t−1, Fⁿ(t−1) is the nth frequency projection vector of the input sample matrix at time t−1,
$${F}^{n} ( t - 1 ) = [ {F}_{1}^{n} ( t - 1 ) , … , {F}_{m}^{n} ( t - 1 ) , … , {F}_{m}^{n} ( t - 1 ) ] , {F}_{m}^{n} ( t - 1 )$$
is the mth frequency projection value of the nth row in the input sample matrix at the previous time t−1, ∥⋅∥ denotes the Euclidean norm of a vector, bⁿ(t) is the weighted cumulative value of the stability of variation for the nth frequency projection vector at time t, where the stability of variation refers to the difference between 1 and the Euclidean distance between the current frequency projection vector and that of the previous time step, bⁿ(t−1) is the weighted cumulative value of the stability of variation for the nth frequency projection vector at the previous time t−1, \hat{F}ⁿ(t) is the nth smoothed frequency projection vector,
$${\hat{F}}^{n} ( t ) = [ {\hat{F}}_{1}^{n} ( t ) , … , {\hat{F}}_{m}^{n} ( t ) , … , {\hat{F}}_{M}^{n} ( t ) ] , {\hat{F}}_{m}^{n} ( t )$$
is the mth smoothed frequency projection value of the nth row input sample at time t, αⁿ(t) is the smoothing coefficient corresponding to the nth frequency projection vector, α(t)=[α¹(t),α²(t), . . . ,α⁶(t)]^{T}, α(t) is the smoothing coefficient vector at time t; combine the smoothed frequency projection vectors to form a frequency embedding matrix, and perform a linear transformation on the frequency embedding matrix to obtain the token representation matrix, calculated as follows:
Z₁(t)=E(t)W₁(t)+b₁(t) (6)
where E(t) is the frequency embedding matrix at time t, E(t)=[\hat{F}¹(t)^{T}, \hat{F}² (t)^{T}, . . . , \hat{F}⁶(t)^{T}], and Z₁(t) is the token representation matrix at time t,
$${Z}_{1} ( t ) = {[ {{Z}_{1}^{1} ( t )}^{T} , … , {{Z}_{1}^{m} ( t )}^{T} , … , {{Z}_{1}^{M} ( t )}^{T} ]}^{T} , {Z}_{1}^{m} ( t )$$
is the mth row vector of the token representation matrix,
$${Z}_{1}^{m} ( t ) = [ {Z}_{1}^{m , 1} ( t ) , … , {Z}_{1}^{m , i} ( t ) , … , {Z}_{1}^{m , D} ( t ) ] , {Z}_{1}^{m , i} ( t )$$
is the element in the ith column of the mth row of the token representation matrix, W₁(t) is the frequency embedding weight matrix, W₁(t) is the
$${W}_{1} ( t ) = {[ {{W}_{1}^{1} ( t )}^{T} , … , {{W}_{1}^{n} ( t )}^{T} , … , {{W}_{1}^{6} ( t )}^{T} ]}^{T} , {W}_{1}^{n} ( t )$$
is the nth row vector of the frequency embedding weight matrix,
$${W}_{1}^{n} ( t ) = [ {W}_{1}^{n , 1} ( t ) , … , {W}_{1}^{n , i} ( t ) , … , {W}_{1}^{n , D} ( t ) ] , {W}_{1}^{n , i} ( t )$$
is the element in the ith column of the nth row of the frequency embedding weight matrix, b₁(t) is the frequency embedding bias vector at time t,
$${b}_{1} ( t ) = [ {b}_{1}^{1} ( t ) , … , {b}_{1}^{i} ( t ) , … , {b}_{1}^{D} ( t ) ] , {b}_{1}^{i} ( t )$$
is the ith frequency embedding bias term, D is the embedding dimension of the token representation, and i=1, 2, . . . , D;
encoder layer: consists of three stacked encoder modules, where s=1,2,3 indicates the index of the sth encoder module, each encoder module sequentially performs frequency projection attention, residual connection, layer normalization, feedforward transformation, another residual connection, and layer normalization on the input token representation matrix, the frequency projection attention operation constructs a frequency projection matrix, which is designed to partition the attention representation into subspaces of new and old patterns, thereby enhancing the model's adaptability to concept drift, the frequency projection matrix is calculated as follows:
P(t)=E(t)a(t)diag (Z₁(t)^{T}Z₁(t))^{T} (7)
where P(t) is the frequency projection matrix at time t, P(t)=[P¹(t)^{T}, . . . , P^{m}(t)^{T}, . . . , P^{M}(t)^{T}]^{T} P^{m}(t) is the mth row vector of the first frequency projection matrix at time t, P^{m}(t)=[P^{m,1} (t), . . . , P^{m,j}(t), . . . , P^{m,M}(t)], P^{m,j} (t) is the element in the jth column of the mth row of the frequency projection matrix at time t, diag(⋅) extracts the diagonal elements of a matrix and outputs them as a column vector, j=1, 2, . . . , M; the query matrix, key matrix, and value matrix of the sth encoder module are calculated as follows:
Qₛ(t)=Zₛ(t)W_{Q,s}(t) (8)
Kₛ(t)=Zₛ(t)W_{K,s}(t) (9)
Vₛ(t)=Zₛ(t)W_{V,s}(t) (10)
where Qₛ(t) is the query matrix of the sth encoder module at time t,
$${Q}_{s} ( t ) = {[ {{Q}_{s}^{1} ( t )}^{T} , … , {{Q}_{s}^{m} ( t )}^{T} , … , {{Q}_{s}^{m} ( t )}^{T} ]}^{T} , {Q}_{s}^{m} ( t )$$
is the mth row vector of the query matrix of the sth encoder module,
$${Q}_{s}^{m} ( t ) = [ {Q}_{s}^{m , 1} ( t ) , … , {Q}_{s}^{m , i} ( t ) , … , {Q}_{s}^{m , D} ( t ) ] , {Q}_{s}^{m , i} ( t )$$
is the element in the ith column of the mth row of the query matrix of the sth encoder module, W_{Q,s}(t) is the query weight matrix of the sth encoder module at time t,
$${W}_{Q , s} ( t ) = {[ {{W}_{Q , s}^{1} ( t )}^{T} , … , {{W}_{Q , s}^{i} ( t )}^{T} , … , {{W}_{Q , s}^{64} ( t )}^{T} ]}^{T} , {W}_{Q , s}^{i} ( t )$$
is the ith row vector of the query weight matrix of the sth encoder module at time t,
$${W}_{Q , s}^{i} ( t ) = [ {W}_{Q , s}^{i , 1} ( t ) , … , {W}_{Q , s}^{i , l} ( t ) , … , {W}_{Q , s}^{i , D} ( t ) ] , {W}_{Q , s}^{i , l} ( t )$$
is the element in the lth column of the ith row of the query weight matrix of the sth encoder module at time t, Kₛ(t) is the key matrix of the sth encoder module at time t,
$${K}_{s} ( t ) = {[ {{K}_{s}^{1} ( t )}^{T} , … , {{K}_{s}^{m} ( t )}^{T} , … , {{K}_{s}^{M} ( t )}^{T} ]}^{T} , {K}_{s}^{m} ( i )$$
is the element in the ith column of the mth row of the key matrix of the sth encoder module at time t,
$${K}_{s}^{m} ( t ) = [ {K}_{s}^{m , 1} ( t ) , … , {K}_{s}^{m , i} ( t ) , … , {K}_{s}^{m , D} ( t ) ] , {K}_{s}^{m , i} ( t )$$
is the element in the ith column of the mth row of the key matrix of the sth encoder module at time t, W_{K,s}(t) is the key weight matrix of the sth encoder module at time t,
$${W}_{K , s} ( t ) = {[ {{W}_{K , s}^{1} ( t )}^{T} , … , {{W}_{K , s}^{i} ( t )}^{T} , … , {{W}_{K , s}^{D} ( t )}^{T} ]}^{T} , {W}_{K , s}^{m} ( t )$$
is the ith row vector of the key weight matrix of the sth encoder module at time t,
$${W}_{K , s}^{i} ( t ) = [ {W}_{K , s}^{i , 1} ( t ) , … , {W}_{K , s}^{i , l} ( t ) , … , {W}_{K , s}^{i , 64} ( t ) ] , {W}_{K , s}^{i , l} ( t )$$
is the element in the lth column of the ith row of the key weight matrix of the sth encoder module at time t, Vₛ(t) is the value matrix of the sth encoder module at time t,
$${V}_{s} ( t ) = {[ {{V}_{s}^{1} ( t )}^{T} , … , {{V}_{s}^{m} ( t )}^{T} , … , {{V}_{s}^{M} ( t )}^{T} ]}^{T} , {V}_{s}^{m} ( t )$$
is the mth row vector of the value matrix of the sth encoder module at time t,
$${V}_{s}^{m} ( t ) = [ {V}_{s}^{m , 1} ( t ) , … , {V}_{s}^{m , i} ( t ) , … , {V}_{s}^{m , D} ( t ) ] , {V}_{s}^{m , i} ( t )$$
is the element in the ith column of the mth row of the value matrix of the sth encoder module at time t, W_{V,s}(t) is the value weight matrix of the sth encoder module at time t,
$${W}_{V , s} ( t ) = {[ {{W}_{V , s}^{1} ( t )}^{T} , … , {{W}_{V , s}^{i} ( t )}^{T} , … , {{W}_{V , s}^{D} ( t )}^{T} ]}^{T} , {W}_{V , s}^{i} ( t )$$
is the ith row vector of the value weight matrix of the sth encoder module at time t,
$${W}_{V , s}^{i} ( t ) = [ {W}_{V , s}^{i , 1} ( t ) , … , {W}_{V , s}^{i , l} ( t ) , … , {W}_{V , s}^{i , D} ( t ) ] , {W}_{V , s}^{i , l} ( t )$$
is the element in the lth column of the ith row of the value weight matrix of the sth encoder module at time t, and l=1, 2, . . . , D;
the output of the frequency projection attention is calculated as follows:
A_{1,S}(t)=softmax(P(t)Qₛ(t)Kₛ(t)^{T}P(t)^{T}) (11)
A_{2,s}(t)=softmax((I-P(t))Qₛ(t)Kₛ(t)^{T}(I-P(t))^{T}) (12)
Oₛ(t)=(A_{1,s}(t)+A_{2,s}(t))Vₛ(t) (13)
where A_{1,s}(t) is the first attention matrix of the sth encoder module at time t,
$${A}_{1 , s} ( t ) = {[ {{A}_{1 , s}^{1} ( t )}^{T} , … , {{A}_{1 , s}^{m} ( t )}^{T} , … , {{A}_{1 , s}^{M} ( t )}^{T} ]}^{T} , {A}_{1 , s}^{m} ( t )$$
is the mth row vector of the first attention matrix of the sth encoder module at time t,
$${A}_{1 , s}^{m} ( t ) = [ {A}_{1 , s}^{m , 1} ( t ) , … , {A}_{1 , s}^{m , j} ( t ) , … , {A}_{1 , s}^{m , M} ( t ) ] , {A}_{1 , s}^{m , j} ( t )$$
is the element in the jth column of the mth row of the first attention matrix of the sth encoder module at time t, I is the identity matrix, A_{2,s} (t) is the second attention matrix of the sth encoder module at time t,
$${A}_{2 , s} ( t ) = {[ {{A}_{2 , s}^{1} ( t )}^{T} , … , {{A}_{2 , s}^{m} ( t )}^{T} , … , {{A}_{2 , s}^{M} ( t )}^{T} ]}^{T} , {A}_{2 , s}^{m} ( t )$$
is the mth row vector of the second attention matrix of the sth encoder module at time t,
$${A}_{2 , s}^{m} ( t ) = [ {A}_{2 , s}^{m , 1} ( t ) , … , {A}_{2 , s}^{m , j} ( t ) , … , {A}_{2 , s}^{m , M} ( t ) ] , {A}_{2 , s}^{m , j} ( t )$$
is the element in the jth column of the mth row of the second attention matrix of the sth encoder module at time t, softmax(⋅) denotes the row-wise normalization of the input matrix such that the sum of each row is equal to 1, Oₛ(t) is the attention output matrix of the sth encoder module at time t,
$${O}_{s} ( t ) = {[ {{O}_{s}^{1} ( t )}^{T} , … , {{O}_{s}^{m} ( t )}^{T} , … , {{O}_{s}^{M} ( t )}^{T} ]}^{T} , {O}_{s}^{m} ( t )$$
is the mth row vector of the attention output matrix of the sth encoder module at time t,
$${O}_{s}^{m} ( t ) = [ {O}_{s}^{m , 1} ( t ) , … , {O}_{s}^{m , i} ( t ) , … , {O}_{s}^{m , D} ( t ) ] , {O}_{s}^{m , i} ( t )$$
is the element in the ith column of the mth row of the attention output matrix of the sth encoder module at time t, perform a residual connection operation and a layer normalization operation on the attention output matrix Oₛ(t) to obtain the residual updated output matrix of the sth encoder module
$${R}_{s} ( t ) , {R}_{s} ( t ) = {[ {{R}_{s}^{1} ( t )}^{T} , … , {{R}_{s}^{m} ( t )}^{T} , … , {{R}_{s}^{M} ( t )}^{T} ]}^{T} , {R}_{s}^{m} ( t )$$
is the mth row vector of the residual updated output matrix of the sth encoder module at time t,
$${R}_{s}^{m} ( t ) = [ {R}_{s}^{m , 1} ( t ) , … , {R}_{s}^{m , i} ( t ) , … , {R}_{s}^{m , D} ( t ) ] , {R}_{s}^{m , i} ( t )$$
is the element in the ith column of the mth row of the residual updated output matrix of the sth encoder module at time t; feed the residual updated matrix into a feedforward neural network, the feedforward neural network consists of a first linear transformation layer with input dimension D and output dimension D, and a second linear transformation layer with input dimension D and output dimension D, with a nonlinear activation layer connected between them, the nonlinear activation function is a rectified linear unit (ReLU), which is used for dimensional reconstruction and feature mapping of the token representation vectors, where the dimension D is equal to the embedding dimension of the token representation; the feedforward output of the sth encoder module is calculated as follows:
\tilde{R}ₛ(t)=ReLU(Rₛ(t)·W_{2,s}(t)+b_{2,s}(t))W_{3,s}(t)+b_{3,s}(t) (14)
where \tilde{R}ₛ(t) is the feedforward output matrix of the sth encoder module at time t,
$${\tilde{R}}_{s} ( t ) = {[ {{\tilde{R}}_{s}^{1} ( t )}^{T} , … , {{\tilde{R}}_{s}^{m} ( t )}^{T} , … , {{\tilde{R}}_{s}^{M} ( t )}^{T} ]}^{T}$$
is the mth row vector of the feedforward output matrix of the sth encoder module at time t,
$${\tilde{R}}_{s}^{m} ( t ) = [ {\tilde{R}}_{s}^{m , 1} ( t ) , … , {\tilde{R}}_{s}^{m , i} ( t ) , … , {\tilde{R}}_{s}^{m , D} ( t ) ] , {\tilde{R}}_{s}^{m , i} ( t )$$
is the element in the ith column of the mth row of the feedforward output matrix of the sth encoder module at time t,
ReLU(⋅) is the rectified linear unit activation function, W_{2,s}(t) is the first linear transformation weight matrix of the sth encoder module at time t,
$${W}_{2 , s} ( t ) = {[ {{W}_{2 , s}^{1} ( t )}^{T} , … , {{W}_{2 , s}^{i} ( t )}^{T} , … , {{W}_{2 , s}^{D} ( t )}^{T} ]}^{T} , {W}_{2 , s}^{i} ( t )$$
is the ith row vector of the first linear transformation weight matrix of the sth encoder module at time t,
$${W}_{2 , s}^{i} ( t ) = [ {W}_{2 , s}^{i , 1} ( t ) , … , {W}_{2 , s}^{i , l} ( t ) , … , {W}_{2 , s}^{i , D} ( t ) ] , {W}_{2 , s}^{i , l} ( t )$$
is the element in the lth column of the ith row of the first linear transformation weight matrix of the sth encoder module at time t, b_{2,s}(t) is the first linear transformation bias vector p encoder module at time t,
$${b}_{2 , s} ( t ) = [ {b}_{2 , s}^{1} ( t ) , … , {b}_{2 , s}^{l} ( t ) , … , {b}_{2 , s}^{D} ( t ) ] , {b}_{2 , s}^{l} ( t )$$
is the lth element of the first linear transformation bias vector of the sth encoder module at time t, W_{3,s}(t) is the second linear transformation weight matrix of the sth encoder module at time t,
$${W}_{3 , s} ( t ) = {[ {{W}_{3 , s}^{1} ( t )}^{T} , … , {{W}_{3 , s}^{i} ( t )}^{T} , … , {{W}_{3 , s}^{D} ( t )}^{T} ]}^{T} , {W}_{3 , s}^{i} ( t )$$
is the ith row vector of the second linear transformation weight matrix of the sth encoder module at time t,
$${W}_{3 , s}^{i} ( t ) = [ {W}_{3 , s}^{i , 1} ( t ) , … , {W}_{3 , s}^{i , l} ( t ) , … , {W}_{3 , s}^{i , D} ( t ) ] , {W}_{3 , s}^{i , l} ( t )$$
is the element in the lth column of the ith row of the second linear transformation weight matrix of the sth encoder module at time t, b_{3,s}(t) is the second linear transformation bias vector of the sth encoder module at time t,
$${b}_{3 , s} ( t ) = [ {b}_{3 , s}^{1} ( t ) , … , {b}_{3 , s}^{l} ( t ) , … , {b}_{3 , s}^{D} ( t ) ] , {b}_{3 , s}^{l} ( t )$$
is the lth element of the second linear transformation bias vector of the sth encoder module at time t, perform a residual connection operation and a layer normalization operation on the feedforward output matrix of the sth encoder module \tilde{R}ₛ(t) to obtain the token representation matrix output b the sth encoder module Zₛ₊₁(t) at time t,
$${Z}_{s + 1} ( t ) = {[ {{Z}_{s + 1}^{1} ( t )}^{T} , … , {{Z}_{s + 1}^{m} ( t )}^{T} , … , {{Z}_{s + 1}^{M} ( t )}^{T} ]}^{T} , {Z}_{s + 1}^{m} ( t )$$
is the mth row vector of the token representation matrix output b the sth encoder module at time t,
$${Z}_{s + 1}^{m} ( t ) = [ {Z}_{s + 1}^{m , 1} ( t ) , … , {Z}_{s + 1}^{m , i} ( t ) , … , {Z}_{s + 1}^{m , D} ( t ) ] , {Z}_{s + 1}^{m , i} ( t )$$
is the element in the ith column of the mth row of the token representation matrix output by the sth encoder module at time t;
output layer: apply a linear regression layer to map the token representation matrix output by the third encoder module to the final output of the model, and the model output is calculated as follows:
ŷ(t)=Z₄(t)W₄(t)+b₄(t) (15)
where ŷ(t) is the predicted output value of the main motor bearing temperature at time t, in degrees Celsius, W₄(t) is the weight vector of the linear regression layer in the output layer at time t,
$${W}_{4} ( t ) = {[ {W}_{4}^{1} ( t ) , … , {W}_{4}^{i} ( t ) , … , {W}_{4}^{D} ( t ) ]}^{T} , {W}_{4}^{i} ( t )$$
is the ith element of the linear regression weight vector at time t, b₄(t) is the bias term of the linear regression layer;
(3) train the parameters of the blower bearing temperature prediction model:
\textcircled{1} define the loss function of the model as:
$$J ( t ) = \frac{1}{2} {( \hat{y} ( t ) - y ( t ) )}^{2} \qquad ( 16 )$$
where J(t) is the loss of the model at time t, y(t) is the actual measured main motor bearing temperature at time t, in degrees Celsius, which is used as a supervision signal for model training;
\textcircled{2} set the current training time to t, initialize the training epoch counter τ=1, and fix the number of training iterations to 20; initialize the model's weight parameters and bias parameters, where the weight parameters are randomly initialized within the range [−0.2, 0.2], and the bias parameters are initialized to 0;
\textcircled{3} compute the actual output of the model at time t during the τth training iteration ŷ^{τ}(t) using equations (1)-(15), compute the loss of the model at time t during the τth training iteration J^{τ}(t) using equation (16), and update the weight matrices and bias vectors using the gradient descent method, with the update formulas given as follows:
$$\{ \begin{matrix}{W}_{1}^{n , i , τ + 1} ( t ) = {W}_{1}^{n , i , τ} ( t ) + 0.01 \cdot \partial {J}^{τ} ( t ) / \partial {W}_{1}^{n , i , τ} ( t ) \\ {W}_{Q , s}^{i , l , τ + 1} ( t ) = {W}_{Q , s}^{i , l , τ} ( t ) + 0.01 \cdot \partial {J}^{τ} ( t ) / \partial {W}_{Q , s}^{i , l , τ} ( t ) \\ {W}_{K , s}^{i , l , τ + 1} ( t ) = {W}_{K , s}^{i , l , τ} ( t ) + 0.01 \cdot \partial {J}^{τ} ( t ) / \partial {W}_{K , s}^{i , l , τ} ( t ) \\ {W}_{V , s}^{i , l , τ + 1} ( t ) = {W}_{V , s}^{i , l , τ} ( t ) + 0.01 \cdot \partial {J}^{τ} ( t ) / \partial {W}_{V , s}^{i , l , τ} ( t ) \\ {W}_{2 , s}^{i , l , τ + 1} ( t ) = {W}_{2 , s}^{i , l , τ} ( t ) + 0.01 \cdot \partial {J}^{τ} ( t ) / \partial {W}_{2 , s}^{i , l , τ} ( t ) \\ {W}_{3 , s}^{i , l , τ + 1} ( t ) = {W}_{3 , s}^{i , l , τ} ( t ) + 0.01 \cdot \partial {J}^{τ} ( t ) / \partial {W}_{3 , s}^{i , l , τ} ( t ) \\ {W}_{4}^{i , τ + 1} ( t ) = {W}_{4}^{i , τ} ( t ) + 0.01 \cdot \partial {J}^{τ} ( t ) / \partial {W}_{4}^{i , τ} ( t )\end{matrix} \qquad ( 17 )$$
$$\{ \begin{matrix}{b}_{1}^{i , τ + 1} ( t ) = {b}_{1}^{i , τ} ( t ) + 0.01 \cdot \partial {J}^{τ} ( t ) / \partial {b}_{1}^{i , τ} ( t ) \\ {b}_{2 , s}^{l , τ + 1} ( t ) = {b}_{2 , s}^{l , τ} ( t ) + 0.01 \cdot \partial {J}^{τ} ( t ) / \partial {b}_{2 , s}^{l , τ} ( t ) \\ {b}_{3 , s}^{l , τ + 1} ( t ) = {b}_{3 , s}^{l , τ} ( t ) + 0.01 \cdot \partial {J}^{τ} ( t ) / \partial {b}_{3 , s}^{l , τ} ( t ) \\ {b}_{4}^{τ + 1} ( t ) = {b}_{4}^{τ} ( t ) + 0.01 \cdot \partial {J}^{τ} ( t ) / \partial {b}_{4}^{τ} ( t )\end{matrix} \qquad ( 18 )$$
$$where {W}_{1}^{n , i , τ} ( t )$$
is the coefficient at the ith column of the nth row of the frequency embedding weight matrix during the τth training iteration at time t,
$${W}_{Q , s}^{i , l , τ} ( t )$$
is the coefficient at the lth column of the ith row of the sth query weight matrix during the τth training iteration at time t,
$${W}_{K , s}^{i , l , τ} ( t )$$
is the coefficient at the ith column of the mth row of the sth key weight matrix during the τth training iteration at time t,
$${W}_{V , s}^{i , l , τ} ( t )$$
is the coefficient at the ith column of the mth row of the sth value weight matrix during the τth training iteration at time t,
$${W}_{2 , s}^{i , l , τ} ( t )$$
is the coefficient at the lth column of the ith row of the first linear transformation weight matrix of the sth encoder module during the τth training iteration at time t,
$${W}_{3 , s}^{i , l , τ} ( t )$$
is the coefficient at the lth column of the ith row of the second linear transformation weight matrix of the sth encoder module during the τth training iteration at time t,
$${W}_{4}^{i , τ} ( t )$$
is the ith coefficient of the linear regression weight vector in the output layer during the τth training iteration at time t,
$${W}_{1}^{n , i , τ + 1} ( t )$$
is the coefficient at the ith column of the nth row of the frequency embedding weight matrix during the (τ+1)th training iteration at time t,
$${W}_{Q , s}^{i , l , τ + 1} ( t )$$
is the coefficient at the lth column of the ith row of the sth query weight matrix during the (τ+1)th training iteration at time t,
$${W}_{K , s}^{i , l , τ + 1} ( t )$$
is the coefficient at the ith column of the mth row of the sth key weight matrix during the (τ+1)th training iteration at time t,
$${W}_{V , s}^{i , l , τ + 1} ( t )$$
is the coefficient at the ith column of the mth row of the sth value weight matrix during the (τ+1)th training iteration at time t,
$${W}_{2 , s}^{i , l , τ + 1} ( t )$$
is the coefficient at the lth column of the ith row of the first linear transformation weight matrix of the sth encoder module during the (τ+1)th training iteration at time t,
$${W}_{3 , s}^{i , l , τ + 1} ( t )$$
is the coefficient at the lth column of the ith row of the second linear transformation weight matrix of the sth encoder module during the (τ+1)th training iteration at time t,
$${W}_{4}^{i , τ + 1} ( t )$$
is the ith coefficient of the linear regression weight vector in the output layer during the (τ+1)th training iteration at time t,
$$\partial {J}^{τ} ( t ) / \partial {W}_{1}^{n , i , τ} ( t )$$
is the partial derivative of J^{τ}(t) with respect to
$${W}_{1}^{n , i , τ} ( t ) , \partial {J}^{τ} ( t ) / \partial {W}_{Q , s}^{i , l , τ} ( t )$$
is the partial derivative of J^{τ}(t) with respect to
$${W}_{Q , s}^{i , l , τ} ( t ) ,$$
$$\partial {J}^{τ} ( t ) / \partial {W}_{K , s}^{i , l , τ} ( t )$$
is the partial derivative of J^{τ}(t) with respect to
$${W}_{K , s}^{i , l , τ} ( t ) , \partial {J}^{τ} ( t ) / \partial {W}_{V , s}^{i , l , τ} ( t )$$
is the partial derivative of J^{τ}(t) with respect to
$${W}_{V , s}^{i , l , τ} ( t ) , \partial {J}^{τ} ( t ) / \partial {W}_{2 , s}^{i , l , τ} ( t )$$
is the partial derivative of J^{τ}(t) with respect to
$${W}_{2 , s}^{i , l , τ} ( t ) , \partial {J}^{τ} ( t ) / \partial {W}_{3 , s}^{i , l , τ} ( t )$$
is the partial derivative of J^{τ}(t) with respect to
$${W}_{3 , s}^{i , l , τ} ( t ) , \partial {J}^{τ} ( t ) / \partial {W}_{4}^{i , τ} ( t )$$
is the partial derivative of J^{τ}(t) with respect to
$${W}_{4}^{i , τ} ( t ) , {b}_{1}^{i , τ} ( t )$$
is the ith frequency embedding bias term during the τth training iteration at time t,
$${b}_{2 , s}^{l , τ} ( t )$$
is the lth bias term of the first linear transformation in the sth encoder module during the τth training iteration at time t,
$${b}_{3 , s}^{l , τ} ( t )$$
is the lth bias term of the second linear transformation in the sth encoder module during the τth training iteration at time t,
$${b}_{4}^{τ} ( t )$$
is the lth bias term of the second linear transformation in the sth encoder module during the τth training iteration at time t,
$${b}_{1}^{i , τ + 1} ( t )$$
is the ith frequency embedding bias term during the (τ+1)th training iteration at time t,
$${b}_{2 , s}^{l , τ + 1} ( t )$$
is the lth bias term of the first linear transformation in the sth encoder module during the (τ+1)th training iteration at time t,
$${b}_{3 , s}^{l , τ + 1} ( t )$$
is the lth bias term of the second linear transformation in the sth encoder module during the (τ+1)th training iteration at time t,
$${b}_{4}^{τ + 1} ( t )$$
is the lth bias term of the second linear transformation in the sth encoder module during the (τ+1)th training iteration at time t,
$$\partial {J}^{τ} ( t ) / \partial {b}_{1}^{i , τ} ( t )$$
is the partial derivative of J^{τ}(t) with respect to
$${b}_{1}^{i , τ} ( t ) , \partial {J}^{τ} ( t ) / \partial {b}_{2 , s}^{l , τ} ( t )$$
is the partial derivative of J^{τ}(t) with respect to
$${b}_{2 , s}^{l , τ} ( t ) , \partial {J}^{τ} ( t ) / \partial {b}_{3 , s}^{l , τ} ( t )$$
is the partial derivative of J^{τ}(t) with respect to
$${b}_{3 , s}^{l , τ} ( t ) , \partial {J}^{τ} ( t ) / \partial {b}_{4}^{τ} ( t )$$
is the partial derivative of J^{τ}(t) with respect to
$${b}_{4}^{τ} ( t ) ,$$
τ=1, 2, . . . , 20;
\textcircled{4} if the training epoch τ<20, increment τ by 1 and return to step \textcircled{3} to continue training; if the training epoch τ≥20, terminate the model parameter training and proceed to step (4) for prediction;
(4) predict the blower bearing temperature: using the trained blower bearing temperature prediction model, take as input the outlet air pressure data, drive-end bearing temperature of the high-speed shaft, vibration data of the high-speed shaft, inlet air temperature data, main motor current data, and historical bearing temperature of the blower's main motor collected at time t, obtain the model output ŷ(t) at time t according to equations (1)-(15), and use the model output as the predicted blower bearing temperature for the next time step following t, in degrees Celsius.

2. The prediction method of claim 1, wherein the spectral reconstructed neural network comprises a frequency-domain projection and adaptive smoothing mechanism configured to reduce the sensitivity of the model to input noise and temporal fluctuations, thereby enhancing the robustness of blower bearing temperature prediction.
